(19) United States
(12) Patent Application Publication
(10) Pub. No.: US 2011/0089030 A1
(43) Pub. Date: Apr. 21, 2011

(54) CIG sputtering target and methods of making and using thereof

(75) Inventors: Daniel R. Juliano, Santa Clara, CA (US); Bao Nguyen, Sunnyvale, CA (US); A. Piers Newbery, Santa Clara, CA (US); Asit Rairkar, San Jose, CA (US); Johannes Vlcek, San Francisco, CA (US); Abdelouahab Ziani, Santa Clara, CA (US)

(73) Assignee: Miasole

(21) Appl. No.: 12/588,578

(22) Filed: Oct. 20, 2009

(51) Int. Cl. C25B 11/04; B05D 1/36; B23K 15/00; B23K 26/00; B22D 19/00; B22D 18/00; B22F 3/02

(52) U.S. Cl. 204/298.13; 204/298.12; 427/404; 228/101; 219/148; 219/121.14; 219/121.64; 164/91; 164/113; 164/47; 419/66; 148/538

(57) ABSTRACT

A sputtering target includes a copper indium gallium sputtering target material on a backing structure. The sputtering target material has a density of at least 100% or more as defined by the rule of mixtures applied to densities of component elements of the sputtering target material. The sputtering target material has an overall uniform composition.

### BACKGROUND

Sputtering techniques are useful in various ways, such as deposition processes used in the fabrication of various products. A component of such sputtering techniques is a sputtering target. In such deposition techniques, the material of the sputtering target is deposited onto a substrate.

### SUMMARY

A sputtering target includes a copper indium gallium sputtering target material on a backing structure. The sputtering target material has a density of at least 100% or more as defined by the rule of mixtures applied to densities of component elements of the sputtering target material. The sputtering target material has an overall uniform composition.

### BRIEF DESCRIPTION OF THE DRAWINGS

FIG. 1 is the copper-indium phase diagram.

FIG. 2 is a side cross sectional view of an exemplary direct forging process and apparatus for producing a sputtering target.

FIG. 3 is a side cross sectional view of an exemplary vacuum mold casting process and apparatus for producing a sputtering target.

FIG. 4 is a perspective cut away view of an exemplary uniaxial powder pressing process and apparatus for producing a sputtering target.

FIG. 5 is a perspective view of an exemplary roll dip casting process and apparatus for producing a sputtering target.

FIG. 6a is an exemplary zone melting process and apparatus for producing a rotary sputtering target via localized melting.

FIG. 6b is an exemplary zone melting process and apparatus for producing a rotary sputtering target with melting providing along the entire length of a backing structure.

FIG. 7a is a side cross sectional view of an exemplary backwards flow pressing method for producing a sputtering target.

FIG. 7b is a perspective view of an exemplary backwards flow pressing method for producing a sputtering target.

FIG. 8a is a side cross sectional view of an exemplary metal injection molding method for producing a sputtering target.

FIG. 8b is a side view of an exemplary metal injection molding method for producing a sputtering target.

FIG. 9a is a diagram showing the flow of various stages of an exemplary semi-solid metal casting process for producing a sputtering target.

FIG. 9b is side cross sectional view of an exemplary semi-solid metal casting process for producing a sputtering target.

FIG. 9c is a side view of an exemplary semi-solid metal casting process for producing a sputtering target.

FIG. 9d is a side view of an exemplary semi-solid metal casting process for producing a sputtering target.

FIG. 10 is a side cross sectional view of an exemplary welding process for producing a sputtering target.

FIG. 11 is a side cross sectional view of an exemplary direct strip casting process for producing a sputtering target.

FIG. 12 is the iron-copper phase diagram.

FIG. 13 is the iron-indium phase diagram.

FIG. 14A is a side cross sectional view of an exemplary in-process sputtering target with a plurality of bond layers.

FIG. 14B is a side cross sectional view of an exemplary sputtering target with a plurality of bond layers.

FIG. 15 is a micrograph showing a side cross section view of an exemplary sputtering target including compatible layer and a diffusion bond layer.

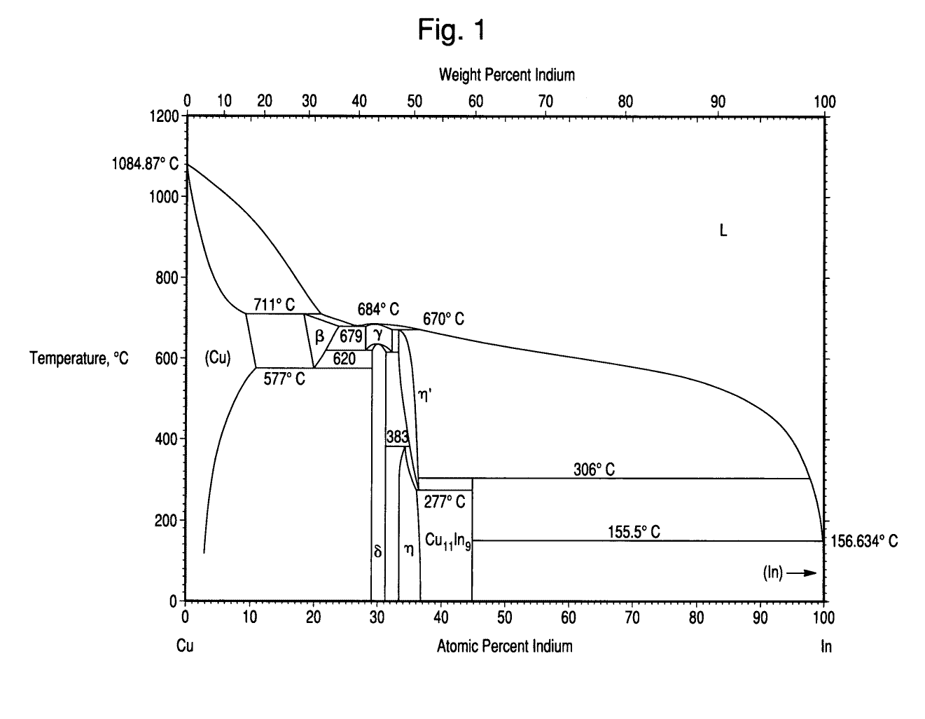

### DETAILED DESCRIPTION

One consideration in selecting and developing sputtering targets is the material to be used in such sputtering targets. Various materials that initially appear to be attractive selections impose manufacturing challenges, particularly from a metallurgical standpoint and particularly when forming the material into a cylindrical or tubular shape. Another consideration is that many monolithic targets formed without a backing tube are not adequate to accommodate water cooling which is provided to the magnets and target assembly during a sputtering operation. Due to this, sputtering materials must often be either bonded to a backing tube or directly formed onto a backing tube, such as a backing tube made from stainless steel or other suitable material.

An exemplary sputtering technique is magnetron sputtering which utilizes magnetrons. Examples of such magnetron sputtering techniques, such as planar magnetron sputtering and rotary magnetron sputtering are discussed in U.S. Pat. No. 7,544,884, issued on Jun. 9, 2009, and which is hereby incorporated by reference in its entirety.

Rotary magnetron sputtering uses cylindrical sputtering targets that include a tube that forms the target material and at least one magnet located inside the tube. Due to the continuous displacement of the magnetic flux lines running through the tube wall as the tube is rotated around the magnets, circumferentially uniform erosion is achieved at the surface of the sputtering target. Such an erosion profile results in higher utilization of the target material in comparison to the erosion profiles provided by other sputtering techniques, such as those employing stationary, planar magnetrons.

One example of a sputtering application is the deposition of materials for solar cells. Copper indium selenide (“CIS”) and copper indium gallium selenide (“CIGS”) materials have been recognized as effective p-type solar cell absorber layer materials for the production of high efficiency, low cost, and large scale solar cells. Copper indium selenide and copper indium gallium selenide materials may be formed by a reactive sputtering from a copper indium or copper indium gallium (“CIG”) sputtering targets, respectively, in a selenium containing ambient, such as selenium gas or hydrogen selenide gas.

CIG alloys possess a large freezing range, with a liquidus temperature over 500° C., often around 650° C., and a solidus temperature of below 160° C. A significant volume change is associated with the solidification and thermal contraction that often occurs over such a wide temperature range. Thus, a substantial amount of shrinkage occurs during solidification of such alloys. Sputtering targets, long in one dimension, having narrow sections and thin walled features, for example, can have porosity due to extensive solidification shrinkage. Inclusions and structural defects, such as voids and porosity, are detrimental to sputtering processes, because such defects can cause arcing and electrical discharges that result in particle generation and the development of thin film anomalies. Phase heterogeneities, such as large areas of indium or copper, can also be detrimental to the sputtering process, so it is desirable that the target material possess a fine-scale microstructure, which is obtained by employing sufficiently rapid cooling during solidification. In addition, large scale variations of composition within a target can lead to sputtered thin films of variable properties across their area and, as a consequence, reduced yield, so the method of CIG target production must limit the amount of macroscopic segregation of constituent elements.

For example, the embodiments of the present invention provide methods of forming a copper indium gallium (“CIG”) alloy sputtering target material. The CIG sputtering target material may be formed directly onto a backing structure, such as a cylindrical backing tube. Such a backing structure can be made from stainless steel or other materials used in the art. Alternatively, CIG segments may be formed separately and then bonded to the backing tube.

The sizes of the primary phase regions are determined using the planimetric technique described in section 12.5 of ASTM standard E1382-97 (2004) and using ASTM E562-08 to calculate volume fraction, in each case substituting primary phase “region” for “grain”. Each primary phase “region” is defined as an entity visible in cross section under SEM with discernable boundaries and surrounded by the indium-rich matrix. In some cases, primary phase regions may have visible cracks but no matrix in the crack, in which case this is still counted as a single primary phase region. Preferably, between 0% and 10%, for instance 1% to 5%, of the primary phase regions (each comprising more than about 40 wt % copper) are of size greater than 100 μm in a random 1 cm by 1 cm area of the sputtering target. More preferably, between 0% and 10%, for instance 1% to 5%, of the primary phase regions are of size greater than 50 μm. Preferably, the average size of the primary phase region is no greater than 40 μm. More preferably, the average primary phase region size is 0.1 to 25 μm, such as 1 to 10 μm.

The CIG sputtering target material can have a density of 100% or more, as determined by the rule of mixtures applied to the densities of the component elements. The density determined this way can be greater than 100% due to the formation of an intermetallic compound with greater density than the pure elements. For example, the sputtering target material has a density of about 100 to 107%, such as 102 to 106%. Preferably, the average level of porosity in the CIG sputtering target material should be 0 to 7 vol %, as determined by microstructural image analysis of representative cross sections, for example. More preferably, the average level of porosity may be 0 to 3 vol %, such as 0.5 to 2.5 vol %. In addition, the CIG sputtering target material should not contain single inclusions or pores large enough to completely contain a 100 μm diameter sphere, preferably it should not contain single inclusions or pores large enough to completely contain a 50 μm sphere. In other words, single inclusions or pores, if present in the material, are small enough to only contain a sphere of less than 50 μm. Non limiting examples of single inclusions are foreign contaminants and/or oxide particles. In addition, the CIG sputtering target material should contain no pores or cracks having a distance of larger than 1000 μm when measured as straight linear distance between ends, more preferably not larger than 500 μm.

The following embodiments will describe various processes to manufacture a CIG sputtering target. Such a sputtering target can, for example, be a rotary magnetron sputtering target, as described above, such as an AC or DC magnetron sputtering target. Alternatively, the methods can be used to form a planar sputtering target. The manufacturing methods described herein can provide a sputtering target with a high density, low residual porosity, a composition with a relatively high uniformity, and a microstructure having a fine distribution of the In-rich phase.

### Direct Forging

According to an embodiment, a direct forging method is provided to produce a sputtering target made of a CIG alloy. Such a direct forging method, for example, can form CIG billets into a thin walled cylindrical sputtering target with a substantially high form factor, such as up to 300, for example 10-300, such as 100-250. The form factor in this case is the ratio of the length to the thickness of the sputtering target. Direct forging methods can use rapid upsetting of materials to form a sputtering target.

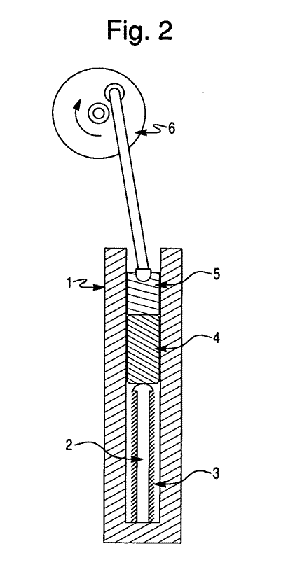

FIG. 2 provides an example of a direct forging method for producing a sputtering target. In such an example a CIG alloy billet can be formed onto a backing tube. Such a direct forging process can utilize a forging press 6 to advance a plunger, ram or piston 5 into a forging die 1, as shown in the example of FIG. 2, causing flow of the sputtering target material 4 within the die 1. Such a forging press 6 can be formed as a wheel that rotates to quickly move a shaft connecting the wheel and the plunger 5, as shown in the example of FIG. 2. However, other forging press 6 configurations can be used in direct forging, such as, for example, piston-cylinder configurations and other configurations used in the art.

To provide shape and a backing substrate for a resultant sputtering target, die 1 can be made as an assembly of two identical splitting die halves closing around core rod 2 and a backing tube 3 to provide a die cavity in which material 4 subjected to plunger 5 pressing action is forced, resulting in a sputtering target with a hollow cylindrical shape, such as those used for rotary magnetron sputtering. The core rod 2 can also be provided to hold the backing tube 3 in place and can cover an open top end of a hollow backing tube 3 so that sputtering target material does not flow into an interior of the hollow cylindrical backing tube 3. In other words, the core rod 2 fills the hollow space in the interior of the backing tube 3.

The entire cylindrical target material 4 is directly forged in a single step as a single piece of CIG material on the backing tube 3. At the completion of plunger 5 stroke, the two halves of die are retracted in opposite directions while the core rod is withdrawn to allow the removal of the targets. Preferably, a bonding layer is not used between the backing tube 3 and the CIG target sputtering material 4.

The material placed within the die 1 to form a sputtering target can be a billet 4 of a CIG alloy. Such a billet can be provided in a solid state produced by conventional techniques (e.g. casting, compacted powder or compacted rapidly solidified flakes) or a semi-solid state (a thixotropic, semi-molten, or slurry state) to facilitate the flow of the sputter target material during the direct forging process. A semi-solid billet can be provided by methods used in the art, such as rheocasting methods described in U.S. Pat. No. 3,902,544, published on Sep. 2, 1975; U.S. Pat. No. 3,948,650, published on Apr. 6, 1976; U.S. Pat. No. 4,089,680, published on May 16, 1978; and U.S. Pat. No. 4,229,210, published on Oct. 21, 1980, each of which are incorporated herein by reference in their entireties; or magnetohydrodynamic methods described in U.S. Pat. No. 5,699,850, published on Dec. 23, 1997; U.S. Pat. No. 4,103,730, published on Aug. 1, 1978; U.S. Pat. No. 4,150,712, published on Apr. 24, 1979; U.S. Pat. No. 4,178,979, published on Dec. 18, 1979; and U.S. Pat. No. 4,200,137, published on Apr. 29, 1980, each of which are incorporated herein by reference in their entireties.

For example, a slurry of a CIG alloy having the composition of 35 wt % Cu, 55 wt % In, and 10 wt % Ga can be provided by mixing the molten alloy at a temperature slightly above the liquidus temperature, i.e. 660° C., with a massive graphite or other suitable material paddle that is cold in relation to the molten alloy. As heat of the molten alloy is conducted through the rotating cold graphite paddle and the temperature of the molten alloy falls below the liquidus temperature, a homogeneous nucleation of the primary phase commences, producing nuclei that grow and are subjected to a shearing action by the graphite paddle. The shearing action promotes the growth of a globular primary phase, which in turn enables the formation of readily flowing slurries upon the partial re-melting of the matrix phase, which is a secondary or low temperature melting phase. In general, a very short, vigorous mixing is sufficient to induce globular growth of the primary phase, which can be maintained while the partially solidified alloy is allowed to complete its solidification to form a rheocast billet.

Upon partial re-melting of the rheocast billet, the volume fraction of the liquid phase can be adjusted such that a readily flowing slurry or “mushy” alloy feedstock is provided. A billet made by conventional casting in a permanent mold does not provide the same flow behavior as a billet made by the above-described methods. For example, the liquid phase of conventionally made billets that is formed upon partial re-melting tends to separated from the remaining solid portion, causing the liquid phase to be typically squeezed out of the body of the billet during forming processes, such as the direct forging process described herein.

By using the direct forging method described herein with a semi-solid billet, as an example, a sputtering target can be produced with a high density, low residual porosity, a composition with a relatively high uniformity, and a microstructure having fine, equiaxed grains. Such a direct forging process can produce a sputtering target with a uniform globular-type microstructure with a reduced amount of residual porosity in comparison to conventional processes for producing sputtering targets. In addition, the direct forging methods described herein provides a cost-effective process for manufacturing sputtering targets, as compared to conventional methods, with improved microstructures and improved quality.

### Vacuum Mold Casting

According to an embodiment, a vacuum mold method is provided to produce a sputtering target. The vacuum mold casting method reduces or overcomes challenges caused by unstable flow of metal, air entrapment, and turbulent flow. These latter factors contribute to macro porosity in a cast article, cold shuts, hot tears, and poor mold filling, which provide sputtering targets with structural defects. For example, a sputtering target with thin features, such as thin walls, can be provided. In addition the sputtering target can have a substantially high form factor, such as, for example, such as up to 300.

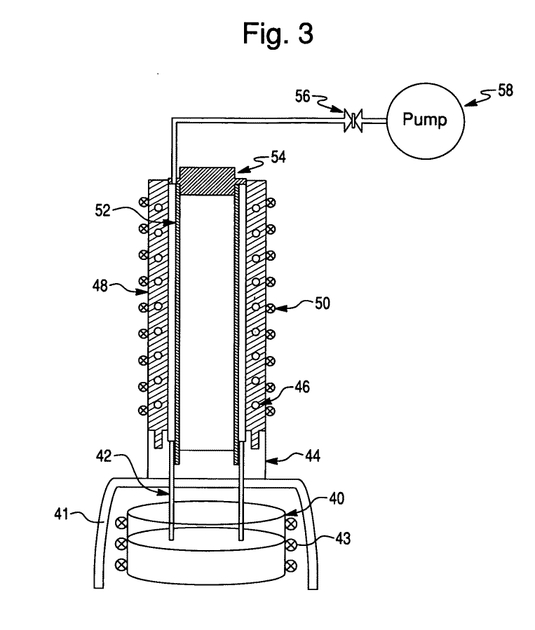

FIG. 3 shows an example of a vacuum mold casting method and apparatus that uses a melting furnace 40 containing a molten alloy. The melting furnace 40 can be provided in open air or inside of a chamber 41 that can control the environment surrounding the melting furnace 40. The chamber 41 can be used to provide a controlled environment around the furnace 40, such as an inert gas atmosphere (e.g., argon, etc.), a low pressure vacuum, an overpressure, or other environments used in the art. A heating device 43 for the melting furnace 40 can be, for example, electrically resistive elements, channels for the circulation of hot fluids, induction coils, a burner or other heating devices used in the art.

A cylindrical backing tube 52 can be provided inside of a mold 48 cavity such that the mold 48 and the backing tube 52 provide a casting cavity between the mold 48 and the backing tube 52. For example, the mold 48 can form an outer contour of the casting cavity while the backing tube 52 forms an inner contour of the casting cavity. The backing tube 52 may be supported in the mold cavity by being inserted into grooves in the mold base 44 or by other positioning devices.

Supplemental heating elements 50 can be provided for the mold 48 and cooling channels 46 can be formed in the mold 48. The cooling channels 46 may comprise fluid channels, such as water, for example, or gas. The heating elements 50 can be, for example, electrically resistive elements, channels for the circulation of hot fluids, induction coils, or other heating devices used in the art. The supplemental heating elements 50 and the cooling channels 46 can be used to control the temperature profile, withdrawal of heat from the mold 48, and the solidification of material within the mold 48.

At least one conduit, such as a tube or pipe 42 can be provided to feed molten material (e.g., the CIG metal alloy) from the melting furnace 40 to a mold cavity formed by the mold 48. Such a tube 42 is immersed within the molten material inside of the melting furnace 40 and is connected through the base 44 of the mold 48. The mold 48 can be sealed by a plug 54 and evacuated to a vacuum or low pressure vacuum through a vacuum tube 56 connected to a vacuum pump 58.

In the operation of the vacuum mold casting process, the vacuum pump 58 can be used to aspire or draw molten material from the melting furnace 40 through the tube 42 and base 44 and into the casting cavity by forming a partial or complete vacuum within the casting cavity of the mold 48. This creates a pressure within the mold 48 that is lower than the pressure exerted upon the molten material in the melting furnace 40. Alternatively, or in addition, the melting furnace 40 can be provided within a pressurized autoclave that can cause molten material to flow through the tube 42 and into the casting cavity of the mold 48 by pressure exerted upon the molten material within the melting furnace 40 so that the molten material in the melting furnace 40 experiences a greater pressure than the pressure within the mold 48.

Upward filling of the casting cavity of the mold 48, as provided by the vacuum mold casting examples described herein, controls the filling of the mold 48 and minimizes or prevents the development of turbulent flow patterns and the formation of casting defects. The upward filling of the cavity also displaces air trapped inside the cavity toward the pump 58 such that this trapped air is removed.

Preferably, the sputtering target material is formed by rapid cooling or rapid solidification of the CIG liquid sputtering target material on the backing structure at a rate of 1-100° C./s, or greater. The method of forming the CIG sputtering target material on the backing tube 52 described above results in the cast target material being directly formed on the backing tube 52 in one step, preferably without the use of a bonding material between the target material and the backing tube. The entire cylindrical target material is vacuum cast as a single piece of CIG material on the backing tube 52. The backing tube with the cylindrical CIG target material formed on its outer surface is then removed from the die cavity.

The supplemental heating elements 50 can be provided to minimize or prevent premature solidification of molten material prior to complete filling of the mold 48 in sections of the casting cavity where heat is extracted quickly. Pre-heating of the mold 48 can ensure improved mold filling and control of the thermal profile throughout the mold 48. Cooling channels 46 can be provided to control the progress of the solidification front within the molten material introduced into the mold 48. Thus, the supplemental heating elements 50 and/or the cooling channels 46 can be provided to control the solidification and thus the resultant microstructure of the molten material introduced into the mold 48. For example, the heat extraction and thermal profile of the mold can be controlled to provide a solidification front that progresses upwards, to control heat extraction of the mold so that excessive growth of microstructural features is minimized or prevented, to provide a continuous feed of molten material in a top region of the mold, and to minimize or prevent the development of isolated molten pockets entrapped within solidified material, which leads to the formation of defects, such as macro porosity.

The vacuum mold casting process described herein can also be used to manufacture a planar target, such as by supporting a planar backing structure within a mold such that a flat surface of the planar backing structure and a surface of the mold provide a casting cavity that molten material is drawn into and cast upon the planar backing structure.

By using the vacuum mold casting method described herein, a sputtering target is produced with a high density, low porosity, a composition with a high uniformity, and a fine-scale microstructure.

### Uniaxial Powder Pressing

According to an embodiment, a uniaxial powder pressing method is provided to produce a sputtering target. The powder can be a sputtering target material, such as a CIG alloy, that has been previously formed, such as, for example, by melting a sputtering target material and atomizing the melt into powder.

In one exemplary method, sputtering target material in the form of powder is directly pressed onto a backing structure. The powder is pressed onto the backing structure with a uniaxial force. For example, when a cylindrical backing tube for a rotary sputtering target is provided, a uniaxial force is applied along the long axis of the backing tube to press the sputtering target material powder directly onto the backing tube. The uniaxial force can cause the sputtering target material powder to deform and expand laterally to the direction of the uniaxial force, which in turn causes the powder to be pressed onto the backing tube.

The sputtering target material may be pressed such that the powder is formed in segments on the backing structure which are compressed together to cover the full area or length of the outer surface of the backing structure. For example, when a cylindrical backing tube is provided as a backing structure the powder can be directly pressed onto the backing tube to form hollow ring or tube shaped segments along the length of outer surface of the backing tube which are joined together to form a sputtering target along the full length of the backing tube, such as a 30-50 inch, such as a 43-48 inch long backing tube.

Various techniques can be used to compress sputtering target material powder onto a backing structure. For example, powder can be cold welded to a backing structure that has been prepared by grit blasting, knurling, or by using specially designed structures or features, such as protrusions and/or grooves on the surface of a backing structure.

In another example, powder can be cold welded to an intermediate compliance layer that has been previously bonded to the backing structure by a bond coating, such as a bond layer described herein. Such a compliance layer can be, for example, indium, gallium, copper, alloys thereof (e.g., CIG, indium gallium, etc.) or another material used in the art.

In another example, cold isostatic pressing (CIP) or warm isostatic pressing (WIP) can be conducted after directly pressing the powder to the backing structure, such as to cold weld the sputtering target material to the backing structure.

In a further example, the powder can be hot welded to an intermediate layer of a low temperature melting material that was previously bonded to the backing structure. The intermediate layer can be made of, for example, indium, gallium, alloys thereof, or other materials used in the art, and can be heated from a reverse side of the backing structure (e.g., by inserting a heating element inside the hollow backing tube) to or above a melting temperature of the intermediate layer. The intermediate layer can be heated while the powder is being pressed to the backing structure.

In another exemplary method, sputtering target material in the form of powder is first pressed into segments separately from a backing structure and these segments are then joined to a backing structure. The powder can be uniaxially compressed to preform the segments separate from the backing structure, with the segments then being assembled and joined to the backing structure. The segments have a hollow ring or tube shape, such that the hollow portion of the ring or tube is a circle having a sufficiently large diameter to accommodate the backing tube. Various techniques can be used to compress sputtering target material powder onto a backing structure. For example, the preformed segments can be assembled onto a backing structure and then uniaxially compressed to the backing structure via cold welding, such as, for example, by grit blasting, knurling, or specially designed structures or features on the surface of the backing structure.

In a further example, preformed segments of sputtering target material powder can be assembled to a backing structure and cold isostatic pressing (CIP) or warm isostatic pressing (WIP) can be conducted to bond the preformed segments to the backing structure, such as to cold weld the sputtering target material to the backing structure.

In another example, preformed segments can be assembled to a backing structure and then uniaxially compressed to the backing structure having an intermediate layer previously bonded to the backing structure, which is heated to an elevated temperature. The intermediate layer can be a bond layer, as described herein, and can be made of, for example, indium, gallium, alloys thereof, or other materials used in the art, and can be heated from a reverse side of the backing structure to a melting temperature of the intermediate layer so that intermediate layer is reflowed to join the preformed segments to the backing structure. Cold reflowing of the intermediate layer can also be performed at room temperature under pressure to a compliance layer that has been previously bonded to the backing structure. Such a compliance layer can be, for example, indium, gallium, copper, alloys thereof, or another material used in the art.

A further technique, which is referred to as Sequential Press of Rotary Target (SPORT), utilizes a press to consolidate sputtering target material powder, by either directly pressing powder onto a backing structure or pressing hollow ring or tube shaped segments that are preformed separately from the backing structure. SPORT is an inexpensive technique in terms of requirements for capital investment and start up costs.

FIG. 4 shows an example of the SPORT technique and apparatus in which a press is provided with a base plate 130, a bottom outer ring 132, and a stackable outer ring 134. A backing tube 136 is placed inside a space formed by the bottom outer ring 132 and the stackable outer ring 134 to form an annular space between an outer surface of the backing tube 136 and inner surfaces of the bottom outer ring 132 and the stackable outer ring 134. An intermediate or compliance layer 140 can be formed on the outer surface of the backing tube 136. A clamp 142 can be placed at the bottom of the backing tube 136 to connect the backing tube 136 to the base plate 130 and to hold the backing tube 136 in position during pressing operations.

Preformed segments of sputtering target material 146 which are separately formed from the backing tube, or sputtering target material powder, are then placed within the annular space provided between the backing tube 136 and the bottom outer ring 132 and the stackable outer ring 134. A pressing ring 144 and stackable press rings 138 are then placed on top of the preformed segments or powder 146 to enclose the preformed segments or powder 146 within the press. A uniaxial force may then be applied in the direction indicated by arrow C in the example of FIG. 4 to press the preformed segments or powder 146 to the backing tube 136. For example, a uniaxial force can be applied to the stackable press rings 138 and/or the pressing ring 144 to compress the preformed segments or powder 146 within the annular space provided between the backing tube 136 and the bottom outer ring 132 and the stackable outer ring 134 so that preformed segments or powder 146 is constrained by the bottom outer ring 132, stackable outer ring 134, and base plate 130, causing the preformed segments or powder 146 to be joined to the backing tube 136. In another example, a heating device can be provided, such as inside the interior of the backing tube 136, to heat the intermediate layer 140 when heating of the intermediate layer 140 is desired. For example, the intermediate layer 140 can be heated so that the intermediate layer is melted or reflowed while the preformed segments or powder 146 is pressed to the backing tube 136. In another example, the SPORT technique can be used with backing structures of other geometries, such as a planar backing structure, such as by providing a press with different components to accommodate backing structures with different geometries.

The exemplary methods of this embodiment can be used for making a rotary sputtering target or a planar sputtering target.

By using the uniaxial powder pressing methods described herein a sputtering target is produced with a high density, low porosity, a composition with high uniformity, and a fine-scale microstructure.

### Dip Casting

According to an embodiment, a dip casting method is provided to produce a sputtering target. In this embodiment a bath of molten sputtering target material, such as, for example, a CIG alloy, is provided. For example, a bath of molten material can be prepared by induction heating, or other heating methods, such as resistive heating, etc. A backing structure is then partially dipped in the bath of molten sputtering target material. Such a method can be used to dip a tubular backing structure into the bath and rotating the tubular backing structure to form a rotary target, or to form a planar target by repeatedly dipping a planar backing structure.

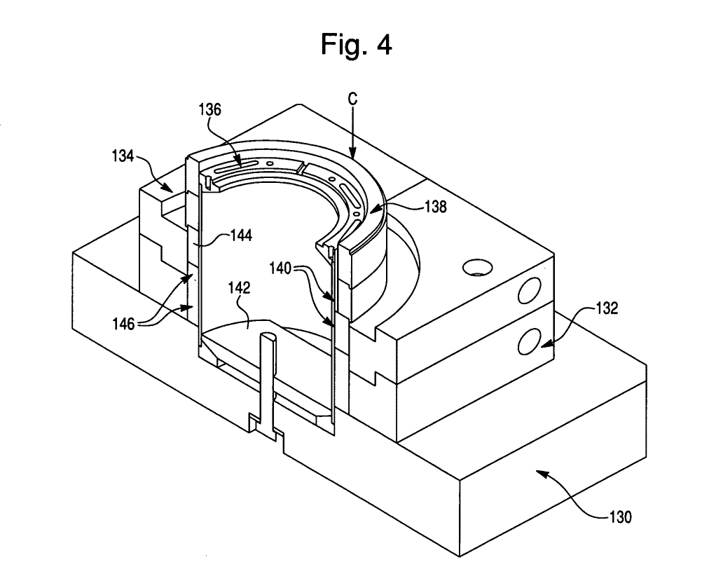

As shown in the example of FIG. 5, to form a rotary target, a crucible 150 of molten material 154 must be of a sufficient size to accommodate a tubular backing structure 152. Such an exemplary rotary backing structure may have a length of about 30-50 inches, for example 44-48 inches. Preferably, the amount of molten sputtering target material in the bath is controlled so that a top surface of the melt is within close proximity to the top edge or lip of the crucible 150.

The backing structure 152 is then lowered into the molten sputtering target material 154 so that an outer surface of the backing structure 152 comes into contact with a top surface of the molten material 154, as shown in the example of FIG. 5. Because the backing structure 152 has a temperature that is lower than the temperature of the molten sputtering target material 154, a layer of sputtering target material 156 is solidified on the outer surface of the backing structure 152. As the backing structure 152 is repeatedly dipped into the molten sputtering target material 154, such as by rotating the tubular backing structure 152 as shown in the example of FIG. 5, the solid layer 156 coats the entire outer surface of the backing structure 152. Optionally, subsequent dips and/or or rotations of the backing structure 152 will cause additional layers of sputtering target material to form over the solid layer 156 of sputtering target material, creating a multi-layered deposit that is sufficient to form a complete sputtering target, such as a cylindrical CIG sputtering target. The dipping or rotation speed of the backing structure 152 can be controlled to in turn control the thickness of the sputtering target or thickness of deposited layers, a decrease in layer thickness caused by an increase in rotation speed, although splashing caused by excessive rotation speed is preferably avoided during the deposition process. The dip depth, the backing structure pre-heat and the melt superheat can also be controlled to vary the thickness of the deposited sputtering target material. It is also preferred that the height of the rotating backing structure is adjustable to take into account changes in melt height or to compensate for changes in the temperature of the melt or nascent target.

According to an example, the backing structure 152 can be internally cooled, such as to ensure that the backing structure and the sputtering target material deposited onto the backing structure remain at a temperature substantially below the solidus temperature of the sputtering target material. Such cooling can be used to rapidly chill layers of sputtering target material deposited onto the backing structure. The amount of backing structure cooling can be controlled to vary the thickness of the deposited sputtering target material. The cooling may be conducted by providing water or other cooling fluid into the hollow interior of the cylindrical backing structure 152 through a conduit, such as a pipe.

According to an example, a bond coat can be provided on the outer surface of the backing structure 152 to facilitate deposition of the first solid layer 156 of sputtering target material and/or to act as a barrier to prevent diffusion of backing structure material into the layers of the sputtering target material. Such a bond coat can be a bond layer as described herein.

In another example, the entire crucible 150, melt of sputtering target material 154, and backing structure 152 can be contained in a controlled atmosphere, such as, for example, an inert atmosphere, such as argon or nitrogen. In another example, the controlled atmosphere can be a vacuum, such as a complete or partial vacuum. The controlled atmosphere may be achieved by enclosing the crucible in a chamber which also accommodates the backing structure. Such a controlled atmosphere can be used to prevent oxidation of the sputtering target material, which could lead to the incorporation of oxide deleterious to the properties of the target. A controlled atmosphere also prevents the formation of significant oxide on the outer surface of each deposited layer of sputtering target material and aids the bonding between subsequent layers.

In another example, the temperature of the backing structure, the temperature of the molten sputtering target material, the dipping depth and/or the dipping frequency or rotation speed of the backing structure can be controlled to influence the affinity of subsequent layers to bond to one another. For example, the outer surface of a layer of solid sputtering target material can be lowered to a temperature sufficient to cause molten sputtering target material to be chilled, causing the molten sputtering target material to freeze to the solid layer, but at a temperature warm enough to ensure that the newly deposited layer of sputtering target material forms a cohesive bond that is substantially indistinguishable during a sputtering process. Preferably, the sputtering target material is formed by rapid cooling or rapid solidification of the CIG liquid sputtering target material on the backing structure at a rate of greater than 10° C./s.

While the method described in FIG. 5 illustrates a horizontal backing structure 152 provided into the melt 154 and rotated, other configurations are possible. For example, the cylindrical tube backing structure 152 may be dipped into the melt while positioned vertically (i.e., with the axis of the tube substantially perpendicular to the melt surface) or in any direction in between vertical and horizontal. Likewise, while the structure 152 is preferably rotated, it may be dipped into the melt 154 without being rotated.

The dip casting method advantageously provides a sputtering target with high yields quickly and in a cost-effective manner with a minimal or negligible risk of macro-scale segregation and without a need for complex mold designs or casting strategies. By using the dip casting method described herein, a sputtering target is produced with a high density, low porosity, a composition with a high uniformity, and a fine-scale microstructure.

### Zone Melting

According to an embodiment, a rapid zone melting method is provided to produce a sputtering target. Such a zone melting method can use sputtering target material in powder or particulate form. This provides the advantages of making sputtering target material in powder form, such as a substantially uniform composition and fine microstructure within each powder pellet or particulate, which is then consolidated into a sputtering target via localized melting or melting that is confined to a portion of the powder or particulate.

According to this embodiment, a sputtering target material, such as a CIG alloy, is provided in a powder and/or particulate form. For example, powder produced via gas atomization or chemical processing and/or flakes or particles produced by melt-spinning can be provided. In another example, the sputtering target material can be provided in other forms, such as a cast form.

Next, the powder and/or particulate may be compacted or pre-sintered to provide a green or raw shape of a sputtering target. For example, the powder and/or particulate may be pressed or pre-sintered onto a backing structure, such as a backing tube or planar backing structure. In the example of a backing tube, the powder and/or particulate sputtering target material is provided on an outside surface of the backing tube. Such backing structures can be provided with one or more coatings (e.g., In, Ga, In—Ga alloy, Cu—In—Ga alloy, etc.) to enhance bonding between the backing structure and the powder and/or particulate sputtering target material, thus improving adhesion between the sputtering target material and the backing structure and improving processing of the sputtering target material and the backing structure.

Localized melting is then performed on the sputtering target material with a fast moving energy source, such as a laser beam. In another example, an electron beam may be used to provide localized melting of the powder and/or particulate sputtering target material. In another example, induction heating may be used to provide the localized melting.

The localized heating is produced by rapid heating of a portion of the powder and/or particulate sputtering target material, which is immediately followed by rapid solidification of the portion that has been melted. The rapid cooling or rapid solidification of the CIG sputtering target material on the backing structure is preferably at a rate of 100-1000° C./s. Such rapid, local melting and cooling advantageously provides a uniform composition and microstructure. Because the source of heat is moved quickly, or heat energy is provided in pulses, the heat input into the sputtering target material rapidly dissipates to surrounding material, causing rapid cooling and rapid solidification of the sputtering target material. Additionally rapid cooling can be provided by cooling devices that withdraw heat from the sputtering target material and/or the backing structure. For example direct cooling with liquid nitrogen or CO₂ can be very effective due to a phase change of the coolant. For example, cooling coil(s) can be provided on a reverse surface of a backing structure that is opposite to a side in contact with the powder and/or particulate sputtering target material. For example, for a backing tube, the cooling coil(s) may comprise at least one pipe or conduit that is located inside the hollow central volume of the backing tube. Such cooling coils can circulate a cooling medium (e.g., water or any other suitable cooling fluid) that withdraws heat from the backing structure, which in turn draws heat from the sputtering target material.

The area of localized melting may be moved, such as by moving the area of localized melting along a long axis of backing tube. The area of localized melting may be moved by moving the heating source relative to the backing tube and/or by moving the backing tube relative to the heating source.

The area of localized melting may be repeatedly moved over and along the sputtering target material to further refine the uniformity, purity, density, and compactness of the sputtering target material. In other words, the sputtering target material is melted or sintered, then solidified or cooled, and then melted or sintered one or more additional times. Such repeated passes of the area of localized melting on the target is preferably in the same direction because the localized melting, by its nature, can diffuse and transport impurities to an end or boundary of the area of localized melting. This causes a region containing impurities to be gradually shifted towards an end of the backing structure, such as an end of a backing tube in relation to a long axis of the backing tube. Such a region of impurities may be removed after localized melting is complete, such as by cutting the region of impurities from the remainder of the sputtering target material.

The localized heating can be conducted within a controlled environment, such as an inert gas atmosphere (e.g., argon, etc.) or a complete or partial vacuum. A cylindrical backing structure can also be rotated about its axis to facilitate localized heating of the powder and/or particulate sputtering target material provided on the backing structure.

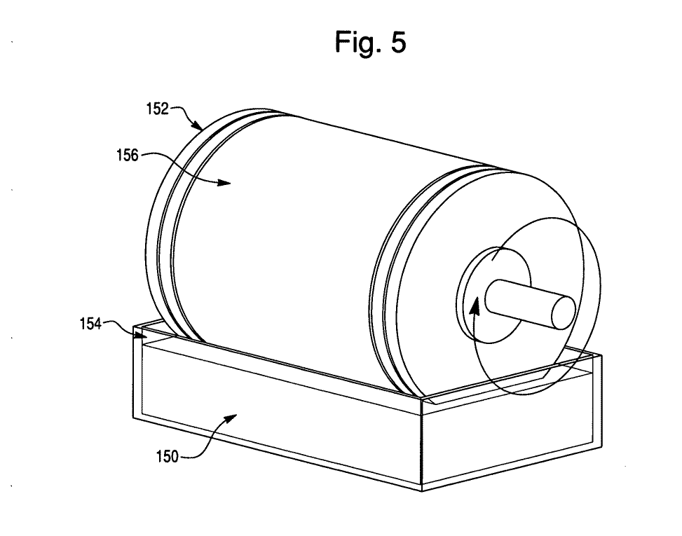

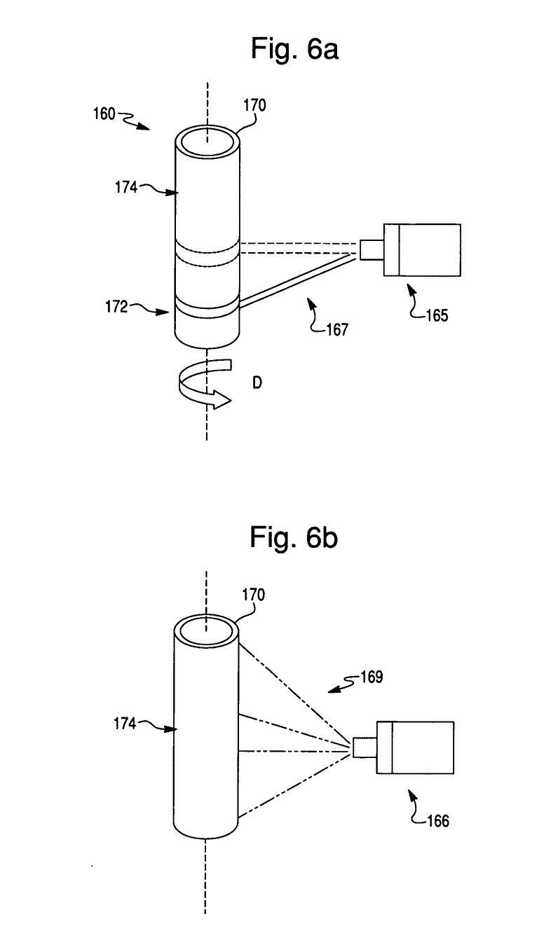

In the exemplary zone melting process and apparatus 160 shown in FIG. 6a, a backing tube 170 is provided with powder and/or particular sputtering target material 174 already provided on the outer surface of the backing tube 170. A heating device 165 to provide localized melting of the sputtering target material 174 is arranged in relation to the backing tube 170 and the sputtering target material 174 provided on the outer surface of the backing tube 170. The localized melting produces a melt zone 172 in the sputtering target material 174, which can be translated along the long axis of the backing tube 170, such as by moving the backing tube 170 and/or control of the heating device 165. The heating device 165 can be any type of heating device configured to provide localized heating and melting. For example, a heating device 165 can be an electron beam device that produces an electron beam 167 such that only a localized portion of the sputtering target material 174 is exposed to the electron beam 167 at a given time, thus causing localized heating and the melt zone 172 in the sputtering target material 174. The beam 167 may be scanned along the target material 174 one or more times, preferably in the same axial direction. The backing tube 170 and sputtering target material 174 may also be rotated in relation to the heating device 165, such as by rotating the backing tube 170 in the direction indicated by arrow D in the example of FIG. 6a.

While an electron beam heating device is shown in FIG. 6a, other heating devices may be used. For example, a laser, lamp, resistive or inductive heating device may be used instead. For beam type heating devices, such as electron beam and laser heating devices, the beam may be moved along the target material. For other types of heating devices, such as lamp, resistive and inductive heating devices, the backing tube may be moved axially past the heating device. Furthermore, although one heating device 165 is shown in the example of FIG. 6a, one or more heating devices can be used. Finally, while one beam 167 is shown, the device 165 may emit several electron or laser beams.

In another example, the device or devices used to cause localized heating of the sputtering target material can be altered so that the heating devices cause heating and melting of an entire portion of the sputtering target material at once. For example, a heating device can be configured to cause heating and melting of sputtering target material along an entire length of a backing structure. In the example shown in FIG. 6b, a backing tube 170 with sputtering target material 174 provided on an outer surface of the backing tube 170 is arranged in relation to a heating device 166. The heating device 166 in this example is configured to cause heating and melting of the sputtering target material 174 along the entire length of the backing tube 170. Such a heating device 166 can be configured to cause heating and melting of the sputtering target material 174 along the entire length of the backing tube 170 on a surface of the backing tube 170 that is exposed to the heating device 166.

For example, when an electron beam device is provided as the heating device 166, the heating device 166 can be configured to produce a wide electron beam 169 that the entire length of the backing tube 170 is exposed to, causing heating and melting of the sputtering target material 174 along an entire length of the backing tube 170. In another example, several electron or laser beams 169 may be incident on the target material at the same time to melt the entire length of the target material. Alternatively, a large area heating source, such as a lamp, resistive or inductive heating source may heat the entire length of the target material 174.

In another example, instead providing a beam 169 that exposes the sputtering target material 174 on the entire length of the backing tube 170 and at once, a heating device 166 can be provided that moves the beam along the length of the of the long axis of the backing tube 170 at a high speed to effectively cause heating and melting along the entire length of the backing tube 170 due to the high translation speed of the beam. In other words, the heating device 166 can move the beam 169 at such a high speed that all portions of the sputtering target material 174 exposed to the beam 169 along the length of the backing tube 170 remain above the melting point of the sputtering target material 174 at a give time.

In another example, the heat sources used to heat a portion of the powder and/or particulate sputtering target material can be used to heat the sputtering target material to cause localized sintering (e.g., solid state consolidation) instead of localized melting. Such localized sintering can be moved along the sputtering target material, similarly to the localized melting examples discussed herein, to consolidate the powder and/or particulate sputtering target material.

By controlling the rapid melting, or sintering, and cooling of the sputtering target material, the growth of alloy phases should be limited and a fine microstructure can be provided.

In addition, by using the zone melting method described herein a sputtering target is produced with a high density, low residual porosity, a composition with a relatively high uniformity, and a microstructure having fine, equiaxed grains.

### Backwards Flow Pressing

According to an embodiment, a backwards flow pressing method is provided to produce a sputtering target. A backward flow pressing method can be used to deform solid sputtering target material into a desired shape. Such a backward flow pressing method creates a significant amount of deformation and/or shear in the sputtering target material. Such significant deformation and/or shear advantageously breaks up relatively coarse features in the sputtering target material and leads to dynamic recrystallization and a fine grain structure. Because CIG alloys have a relatively low compression yield strength (about 10 MPa or less), CIG alloys are suitable for backwards flow pressing and a reasonably sized tool can be used in a backwards flow pressing process of a CIG alloy. Backwards flow pressing can provide advantages over extrusion processes, such as providing sputtering target directly onto a backing structure, such as a backing tube, in a net or near net shape with minimal final machining.

For example, when a rotary sputtering target is desired, a billet of sputtering target material, such as a CIG alloy, can be provided and pressed into the shape of a hollow tube. The billet of sputtering target material can be produced by any casting methods discussed herein or used in the art. The billet can be cast under a protective atmosphere, such as an inert gas atmosphere (e.g., argon, etc.), a low pressure vacuum, an overpressure, or other environments used in the art. The billet can also be machined to a predetermined dimension desired for a backwards flow pressing process, such as a dimension required for the tooling of a backwards flow pressing apparatus.

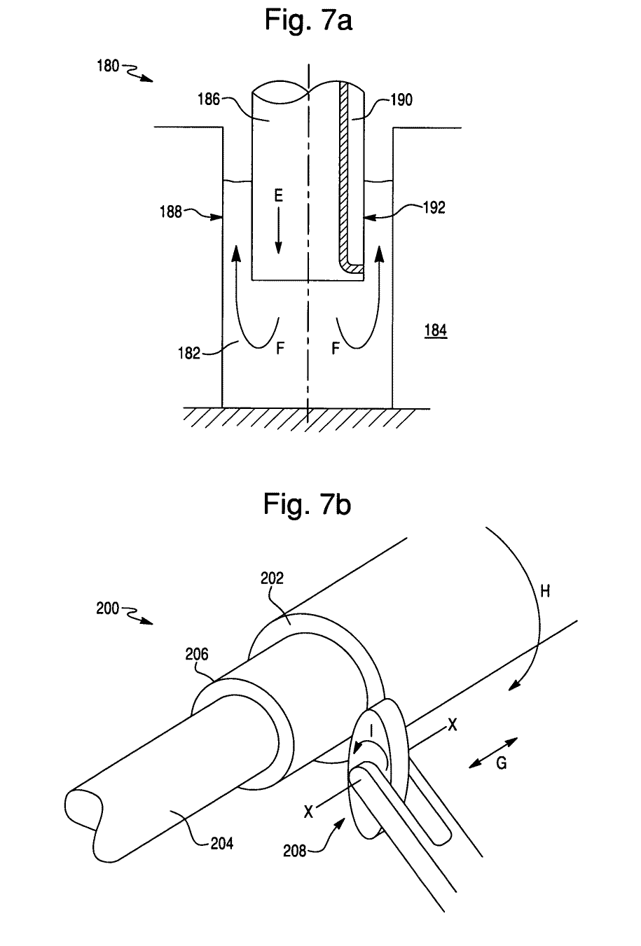

FIG. 7a shows an exemplary backwards flow pressing apparatus 180. A billet 182 of sputtering target material can be introduced into a tool 184 after the billet 182 has been prepared. The billet 182 can be cylindrical with measurements that meet any requirements for the dimensions of the tool 184 and the amount of filling and volume required in the subsequent backwards flow pressing operation. In another example, sputtering target material may be directly cast within the cavity of the tool 184 and subsequently processing with the tool 184 and die 186 of the backwards flow pressing apparatus 180. Preferably, the billet 182 is maintained in the semi-solid state.

A die 186 can then be introduced into the tool 184 in the direction indicated by arrow E in FIG. 7a and pressed against the billet 182, causing the billet 182 to deform and flow around the outer surface of the die 186 and against the inner surface 188 of the tool 184, as shown by the direction indicated by arrows F in FIG. 7a. The inner surface 188 of the tool 184 can be treated to reduce friction between the sputtering target material of the billet 182 and tool 184, such as by machining the inner surface 188 to a low surface roughness and/or coating the inner surface 188 with a coating. The outer surface of the die 186 may also be treated to reduce friction between the die 186 and the sputtering target material of the billet 182. By pressing the die 186 into the tool 184, the billet 182 is deformed and caused to flow around the die 186, forming the billet 182 into a hollow tube. The billet 182 of sputtering target material, once in the form of the hollow tube, can be subsequently removed from the tool 184, treated (if desired), and attached to a backing structure, such as a backing tube, during a bonding process. The sputtering target may be heat treated, if desired. Preferably, the tool 184 is an open cylinder while the die 186 is a closed cylinder which fits into the tool 184. Other shapes can be used.

In another example, a cryo-assembly operation can be performed, such as by chilling a rotary backing tube to a relatively low temperature to contract the backing tube, inserting the chilled rotary backing tube within the central opening in the sputtering target material deformed by the backwards flow pressing operation, and subsequently bonding the rotary backing tube to the sputtering target material, and heat treating the assembly, if desired.

In another example, the die can be provided with a tubular backing structure attached to the outer surface of the die 186. In this example, the billet may be directly formed onto backing structure, to form a sputtering target with little or no further processing required. As shown in the example of FIG. 7a, a rotary backing tube 190 can be provided on the die 186 as a sleeve on the outer surface of the die 186 so that the sputtering target material of the billet 182 is directly formed or bonded onto the rotary backing tube 190 as the die 186 is pressed into the tool 184 and the billet 182 is deformed around the die 186. The outer surface 192 of the rotary backing tube 190 can be treated to enhance bonding or friction between the rotary backing tube 190 and the sputtering target material of the billet 182 to promote adhesion and bonding between the rotary backing tube 190 and the sputtering target material.

FIG. 7b shows another example of a backwards flow pressing process 200 in which raw sputtering target material 202, such as a billet of CIG alloy, can be pressed against the end of a mandrel or backing tube 204. As the mandrel or backing tube 204 is pressed against the raw sputtering target material 202, the raw sputtering target material 202 is rotated, such as in the direction indicated by arrow H of FIG. 7b. A tool 208 is pressed against the raw sputtering target material 202 to cause the raw sputtering target material 202 to deform around the mandrel or backing tube 204 in the form of a hollow tube 206, as shown in the example of FIG. 7b.

The tool 208 can be a roll or wheel rotating in the direction indicated by arrow I in the example of FIG. 7b and the tool 208 can be moved in the tube 204 axial direction indicated by arrow G in FIG. 7b as the tool 208 causes the raw sputtering target material 202 to be deformed into the hollow tube 206. In this example, the raw sputtering target material 202 can be deformed by the tool 208 into the form of the hollow tube 206 on a mandrel 204, with the hollow tube 206 of sputtering target material removed from the mandrel 204 after the process is complete so that the sputtering target material may be attached and/or bonded to a backing structure. Alternatively, the hollow tube 206 can be directly formed and/or bonded onto a backing tube 204 so that a sputtering target is produced by the process of FIG. 7b with little or no subsequent processing. The backwards flow pressing process 200 of the example of FIG. 7b can be performed in a lathe or other similar machines used in the art.

In addition, by using the backwards flow pressing process described herein, a sputtering target is produced with a high density, low residual porosity, a composition with a relatively high uniformity, and a microstructure having fine, equiaxed grains.

### Metal Injection Molding

According to an embodiment, a metal injection molding method is provided to produce a sputtering target. The metal injection molding method utilizes powder of metals and/or metal alloys mixed in a predetermined ratio to provide the material for a sputtering target having a desired composition. For example, a sputtering target made of a CIG alloy can be manufactured via a metal injection molding process by providing a mixture of copper, indium, and gallium powders in a predetermined ratio, which can then be compacted and sintered to form a sputtering target. The various metal powders provided in a powder mixture can be mixed by a pre-mixing device to ensure a substantially uniform, homogeneous composition in the powder mixture before further processing, such as compaction and sintering.

A binder can also be included in the powder mixture to hold the powder particles together before and after compaction and to enhance the rheological properties of the metal powder. The binder is used to provide the powder mixture with a low viscosity so that the powder mixture can be used similarly to plastic injection molding and can be held together in a desired shape once the powder mixture is pressed during compaction.

The binder is extracted after or during a compaction operation, such as by a thermal or chemical process. For example, a plastic binder can be used, which can be removed from a compacted powder form by heating the compacted powder form to a temperature higher than a boiling or evaporation point of the binder but lower than the melting points of the metal powder, causing the binder to evaporate and flow out of the compacted powder form. Such a heating step can be a separate step, part of a sintering step, or a part of a combined compaction and sintering operation, such as when hydrostatic pressure and sintering at an elevated temperature are conducted to ensure compaction. In another example the binder can be removed by a chemical treatment that dissolves the binder but leaves the metal powder in the compacted powder form.

The compaction step can use hydrostatic pressure to press the metal powder particles and binder into a desired shape, which is then sintered at an elevated temperature to provide a sputtering target of a desired shape and density.

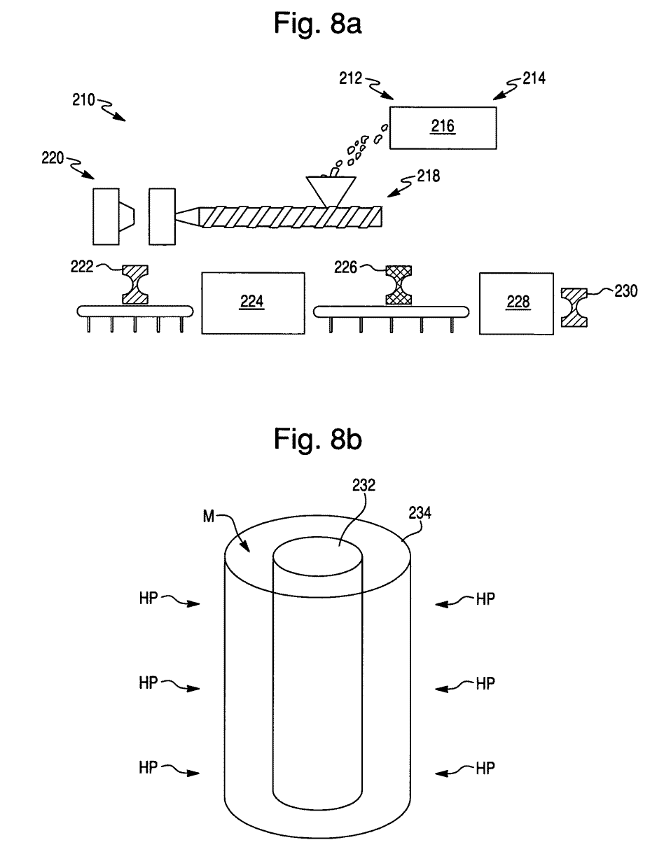

As shown in FIG. 8a, which shows an exemplary metal injection molding process 210, metal powder 212 and binder 214 can be provided to a mixing device 216 that mixes the metal powder 212 and binder 214 in a substantially uniform mixture that is then provided to a delivery device 218, such as an auger. The metal powder 212 can contain predetermined amounts of various metal powders and/or metal alloy powder to provide a powder mixture with a composition desired for a sputter target material. For example, the metal powder 212 can contain copper, indium, and gallium metal powders so that a CIG alloy sputtering target of a desired composition can be produced. Examples of the powders include Cu, In and Ga powders, CuGa alloy and In powders, GuGa alloy and CuIn alloy powders, CuIn alloy and Ga powders, etc.

The delivery device 218 may then provide the powder mixture to a mold or die 220 that is used to compact the powder mixture into a compacted powder form 222 of a desired shape. The delivery device 218 can be configured to forcefully deliver the powder mixture into the mold or die 220 to assist in the compaction and formation of the powder mixture into the desired shape. In addition, a hydrostatic pressure can be applied to the mold or die 220. A backing structure can be provided within the mold or die 220, as will be discussed in further detail. The delivery device 218 can also be used to continuously stir the powder mixture at or near room temperature while the powder mixture is being injected into a mold

The compacted powder form 222 can then be delivered to a debinding device 224 to remove the binding material from the compacted powder form 222 to produce an unsintered powder compact 226, such as by heating the compacted powder form 222 to a temperature higher than the evaporation point of the binding material or by chemically treating the compacted powder form 222.

The unsintered powder compact 226 can then be delivered to sintering furnace 228 so that the unsintered powder compact 226 can be heated to an elevated temperature to cause sintering to produce a sintered sputtering target 230 of a desired shape and high density while maintaining a uniform composition and without segregation of metal into intermetallic phases.

It should be noted that one or more of the devices and steps described above can be combined, such as to provide a process with fewer steps and equipment. For example, the compaction and debinding operations can be performed by a single device to provide an unsintered powder compact 226. In another example, the debinding and sintering steps can be performed by a single device.

FIG. 8b shows an example of a metal injection molding process for producing a rotary (i.e., cylindrical or tubular) sputtering target in which a mold 234 and an inner rotary backing tube 232 is provided. A mixture of metal powder and binder M can be introduced into the space provided between the mold 234 and the rotary backing tube 232. Once the mixture M has been provided, hydrostatic pressure HP can be exerted on the mold to compact the mixture M into a desired shape around the rotary backing tube 232. Debinding and sintering of the powder mixture M can also be conducted on the mixture M between the rotary backing tube 232 and the mold 234 once compaction of the mixture M is complete. The mold 234 and the rotary backing tube or substrate 232 can be used to produce rotary sputtering targets in whole or in sections. In the latter example, a smaller mold 234 and rotary backing tube or substrate 232 can be provided to produce ring shaped sections of rotary sputtering targets, which may then be joined together to form the cylindrical or tubular target. In another example, the hydrostatic pressure HP can be provided in a vertical direction, perpendicular to the directions indicated by arrows HP in the example of FIG. 8b, so that the powder mixture M is compacted along the long axis of the mold 234, such as with a uniaxial vertical hydrostatic pressure HP.

The metal injection molding process advantageously provides a sputtering target with a substantially uniform composition and near-bulk density. In addition, the composition of the resulting sputtering target can be readily controlled, such as by adding additional alloying elements. For example, selenium and/or sodium can be readily added without a significant increase in manufacturing cost.

In addition, by using the metal injection molding process described herein using a solid metal powder, a sputtering target is produced with a high density, low residual porosity, a composition with a relatively high uniformity, and a microstructure having fine, equiaxed grains.

### Semi-Solid Metal Casting

According to an embodiment, a semi-solid metal casting method is provided to produce a sputtering target. Semi-solid metal casting molding is conducted by casting or molding a sputtering target material, such as a CIG alloy or a copper-indium-gallium-selenium alloy, in the semi-solid state. Preferably, the method also includes mixing the semi-solid sputtering target material as it cools and solidifies to break up dendritic structures in the material to achieve a thixotropic state. The resulting cast or molded material has a fine microstructure of substantially uniform composition. Controlling solidification of the sputtering target material via mixing during cooling advantageously minimizes segregation. Such a mixing process can be accomplished via mechanical stirring, electromagnetic induction, or other methods used in the art. The mixing process can be conducted within a pre-casting chamber to create a semi-solid billet that is then placed in a shot chamber and injected into a mold. Alternatively, the mixing can be conducted within the shot chamber or the mold.

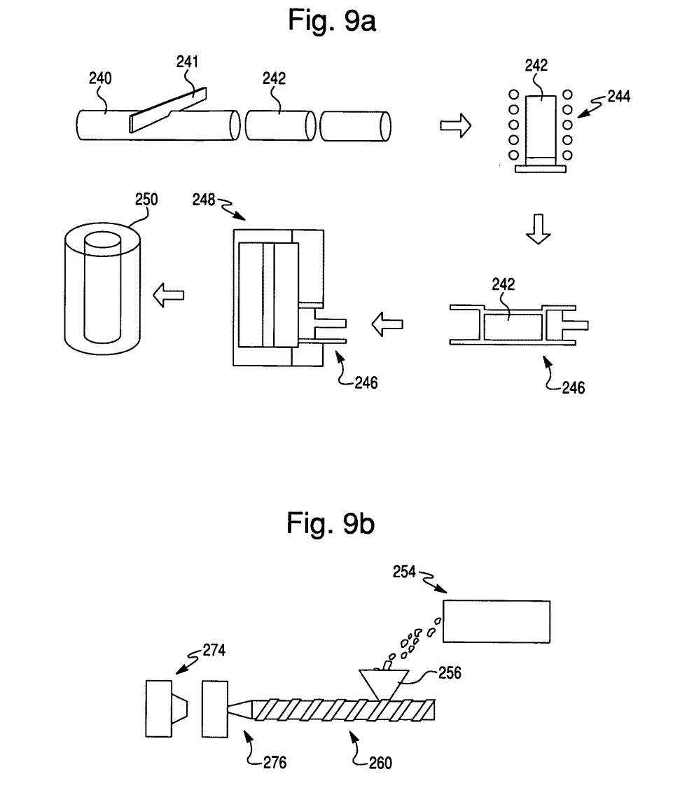

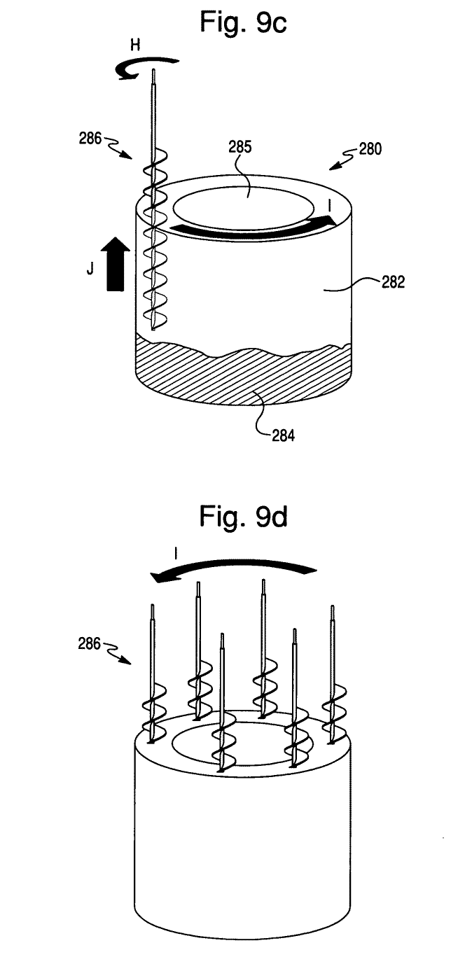

FIG. 9a shows the flow of steps in an exemplary semi-solid metal casting process, which is also sometimes referred to as thixocasting or thixoforming which uses the semi-solid billet (see www.azom.com/details.asp?articleID=1373). The steps in the figure advance in a clockwise direction from the upper left corner of FIG. 9a. In a first step, raw sputtering target material 240 is cut into slugs or billets 242 of a desired size by a cutting device 241. In a second step, a slug 242 is placed within a heating device 244, such as an induction heater, which heats the slug 242 so that the sputtering target material is semi-solid. The semi-solid slug or billet 242 is then transferred to a shot sleeve 246 that is attached to a mold 248 and the piston or driver within the shot sleeve 246 is advanced to force the material of the semi-solid slug 242 into the cavity of the mold 248, providing a cast sputtering target 250 of a desired shape with a uniform composition and fine microstructure with minimal segregation. Mixing of the semi-solid sputtering target can be accomplished within the heating device 244, such as by electromagnetic induction, within the shot sleeve 246, and/or within the cavity of the mold 248.

FIG. 9b shows another exemplary semi-solid metal casting process 252, which is sometimes called semi-solid injection molding. This method does not use a billet, but instead uses the same apparatus to form a semi-solid or thixotropic material and inject it into a mold.

The sputtering target material 254 is provided a form of pellets, powder, and/or particles of sputtering target material to a hopper or another storage device 256. The material 254 is then fed from hopper 256 to a barrel shaped shot chamber 260 which contains a screw or auger. While a single barrel apparatus is shown in the figure, it should be noted that multi-chamber apparatus may also be used. The barrel 260 is heated to make the sputtering target material semi-solid within the barrel 260. The barrel is heated to convert the material 254 to the semi-solid state while the screw is rotated to shear the dendrites to make the material 254 thixotropic. The screw or another shot piston device is then advanced to deliver the thixotropic sputtering target material 254 from the barrel through a nozzle 276 to a mold 274. A non-return valve may be provided to prevent the sputtering target material from surging backwards into the barrel, causing an extrude accumulation at the nozzle 276. The sputtering target cast within the mold 274 have a uniform composition and fine microstructure with minimal segregation. The cast target material may be attached to the backing tube or plate or the backing tube or plate may be located in the mold 274 to directly form the sputtering material thereon.

FIG. 9c shows an exemplary semi-solid metal casting process, also referred to as rheocasting or rheomolding, in which molten sputtering target material is continuously mixed while the sputtering target material is cooled from a liquid state through a semi-solid state to a solid state. This method differs from the thixoforming method in that a separate billet is not used and the material is preferably not solidified and then converted to the semi-solid state (i.e., billet) and then solidified in the mold. This method differs from the semi-solid injection molding method in that the semi-solid material is not injected into a mold from a shot chamber. Instead, the material is cooled and mixed directly in the casting mold.

In such an example, molten sputtering target material 282 can be provided in a mold 280 and a mixing device 286 is provided to continuously mix the molten sputtering target material 282 as the sputtering target material cools and solidifies to form solid sputtering target material 284. In the example shown in FIG. 9c the mixing device 286 is a screw or auger, similar to a drill, that can be rotated in the direction indicated by arrow H in FIG. 9c. In addition, the mixing device 286 can move within the mold 280 to mix various areas of the molten sputtering target material 282. In the example of FIG. 9c, which depicts a mold 280 for a cylindrical rotary sputtering target, the mixing device 286 can move within the mold 280 so that the mixing device 286 revolves circumferentially about a center axis of the mold 280, such as in the direction indicated by arrow I in FIG. 9c. Furthermore, the mixing device 286 can be withdrawn as the molten sputtering target material 282 solidifies, such as in the direction indicated by arrow J in the example of FIG. 9c. Such withdrawal of the mixing device 286 can be done continuously as the molten sputtering target material solidifies.

In a further example, the inner surface 285 of the mold 280 shown in the example of FIG. 9c can be rotated relative to the remainder of the mold 280 to create shear within the molten and/or semi-solid sputtering target material within the mold 280. The shear breaks up dendrites to achieve the thixotropic state.

FIG. 9d shows another exemplary embodiment of a semi-solid metal casting process that is similar to the embodiment of FIG. 9c except that plurality of mixing devices 286 are provided in the mold. The mixing devices 286 can be stationary or can revolve circumferentially, as indicated by arrow I in the example of FIG. 9d. In addition, the mixing devices 286 can be withdrawn as sputtering target material within the mold solidifies.

Mechanical mixing devices preferably cause turbulent flow and mixing of molten sputtering target material and are designed to operate in this manner. Such turbulent mixing advantageously promotes homogeneity of the melt composition until solidification occurs.

The semi-solid metal casting examples discussed herein can be used to produce a single piece, monolithic sputtering target or can be used to produce ring shaped sputtering target sections that are subsequently joined together. In addition, the sputtering target material may be cast directly onto a backing structure. For example, a backing tube can be placed within the mold of the examples of FIGS. 9c and 9d (e.g., over the inner surface 285 of the mold) to produce a rotary tubular sputtering target by casting the sputtering target material directly onto the backing tube. In another example, a sputtering target, or sections or sputtering target, can be molded separately from a backing structure and then subsequent joined to the backing structure. The exemplary processes described herein can also be used to produce planar sputtering targets.

In addition, by using the semi-solid metal casting process described herein a sputtering target is produced with a high density, low residual porosity, a composition with a relatively high uniformity, and a microstructure having fine, equiaxed grains.

### Welding Process

According to an embodiment, a welding process is provided to produce a sputtering target. A welding process can be used to provide at least one cladding layer of sputtering target material, such as a CIG alloy or copper-indium-gallium-selenium alloy or other alloys used in the art, on the surface of a backing structure. Various melding methods can be used to produce a cladding layer of a sputtering target material on a substrate or backing structure, such as, for example, manual metal arc (MMA) welding, tungsten inert gas (TIG) welding, metal inert gas (MIG) welding, plasma welding, electron beam welding, laser welding, and other welding methods used in the art.

The sputtering target material can be fed to the welding process in various forms and in different manners. For example, the sputtering target material can be provided to a welding device as a wire (cored or solid), powder, stick, rod, or other metallic forms used in the art. In addition, the sputtering target material can be provided as elemental metals or in alloyed form.

The sputtering target material provided to a welding device is melted by heat produced by the welding device to create a molten weld bead on a backing structure or substrate. The weld bead can form a strong metallurgical bond with the backing structure or substrate. Subsequent passes of the welding device to deposit additional weld beads of the sputtering target material strongly bond the subsequent beads to weld beads deposited during previous passes of the welding device. Due to the size of the weld bead and fast removal of heat from the weld bead, the weld bead solidifies relatively fast, creating an overall sputtering target with minimal segregation and porosity. In addition, the welding process can be manually operated or automated and the parameters of the welding process can be readily controlled, such as to provide cladding layers of various thicknesses, to produce sputtering targets of consistent quality at relatively low cost. Automation of the welding process can be advantageously used to provide relatively precise thickness control of the cladding layer deposited.

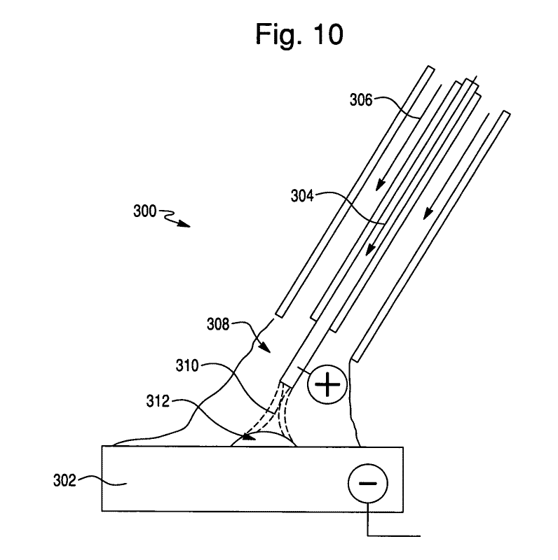

FIG. 10 shows an example of a welding process 300 in which a weld bead 312 is deposited on a backing structure 302 to produce a sputtering target. The example shown in FIG. 10 is a MIG process in which sputtering target material, such as a CIG alloy, is provided in the form of a wire electrode 304 fed through the welding device. A gas flow conduit 306 is provided around the wire electrode 304 to provide a gas flow concentric to the wire electrode 304 and to produce a gas shroud 308. The shroud is provided around the wire electrode 304, an area 310 where an arc is struck between an end of the wire electrode 304 and the backing structure 302, and an area where sputtering target material is transferred from the wire electrode 304 to the backing structure 302 to form the weld bead 312. The heat of the arc causes the metal sputtering target material of the wire electrode 304 to melt and the bead to be deposited on the backing structure 302. In the example shown in FIG. 10 a DC voltage can be applied between the wire electrode 304 and the backing structure 302.

The gas used in the gas flow conduit 306 and shroud 308 can be an inert gas to protect the wire electrode, weld bead, and/or backing structure, or an active gas, such as carbon dioxide, that reacts with the molten metal in a desired way to affect the properties of the weld bead and the process parameters.

The wire electrode 304 can be continuously fed through the welding device and the area 310 of the arc so that weld beads can be continuously formed on the backing structure 302 to form a cladding layer. In addition, the welding device can be moved relative to the backing structure 302 so that the weld beads 312 deposited by the welding device are formed along an outer surface of the backing structure 302 to form the cladding layer. As the welding device and the heat provided by the welding device move away from a deposited weld bead, the weld bead quickly solidifies to form a layer of sputtering target material on the backing structure.

Such cladding layers can be built up to a desired thickness by controlling the processing parameters of the welding process, such as filler material feed rate, traversing speed of the welding device, and the number of passes the welding devices makes over a given area of a backing structure. For example, multiple passes of a welding device can be made over the same area of a backing structure to build up one weld bead on top of another to provide a cladding layer of a desired thickness.

The examples of welding processes described herein can be used to produce sputtering targets of various geometries, such as rotary sputtering targets and planar sputtering targets.

In addition, by using the welding process described herein a sputtering target is produced with a high density, low residual porosity, a composition with a relatively high uniformity, and a microstructure having fine, equiaxed grains.

### Beam Processing of Sputtering Target Material

According to an embodiment, a beam processing method is provided to produce a sputtering target. In such beam processing method a powder or particulate sputtering target material provided on a backing structure or substrate is melted with a beam that provides heat to the sputtering target material. The beam can be in the form of, for example, an electron beam, a laser beam, or beams of other particles and energy used in the art. This method may also be referred to as beam welding, such as electron or laser beam welding.

The sputtering target material can be prepared via gas atomization, chemical processing, or other methods used in the art to provide metal powder or particulates. The sputtering target material can be elemental metals mixed together to form a desired composition, an alloy, or a mixture thereof. The sputtering target material can be, for example, a CIG alloy or other alloy used in the art.

In one example, powder or particulate sputtering target material is deposited on the surface of a backing structure or substrate in a pattern desired for a sputtering target. A beam for providing heat to the powder or particulate material is applied to the powder or particulate sputtering target material to cause the material to melt. The beam may be moved or scanned over the areas of the backing structure covered with sputtering target material. As the beam is moved, the sputtering target material is first melted by the heat provided by the beam and then quickly cooled as the beam moves away from the melted sputtering target material, due to the size of the melted sputtering target material and the withdrawal of heat from the melted portion of sputtering target material. As the molten sputtering target material solidifies, the sputtering target material forms a strong bond with the underlying backing structure or substrate. Additional powder or particulate sputtering target material may be further deposited on top of the solidified sputtering target material and melted with the beam to provide additional layers and a desired thickness for a sputtering target.

In another example, a pool of molten material can be formed on a backing structure or a substrate by a beam, such as by maintaining the beam at a desired location, and powder or particulate sputtering target material can be added to the molten pool. The beam may then be moved away from the location of the first molten pool to form another molten pool in a different location where powder or particulate sputtering target material is added once again, permitting the first molten pool to solidify on a surface of the backing structure or substrate. This process can be repeated to form a layer of sputtering target material on the backing structure or substrate by forming a molten pool in a given location on the backing structure or substrate, adding powder or particulate sputtering target material to the molten pool, moving the beam away from the molten pool to permit the molten pool to solidify, and repeating this process. The initial molten pool can be formed by heating the backing structure or substrate itself and/or by providing an initial layer of powder or particulate sputtering target material on the backing structure or substrate.

Due to the relatively small size of the molten portion of sputtering target material, the sputtering target material quickly solidifies once the beam is moved away from the molten portion, causing the molten portion to solidify quickly with a fine, uniform composition. Additional cooling can be provided to enhance and further control the cooling conditions for the molten portion of sputtering target material, such as by providing additional cooling to the backing structure or substrate and/or by providing a flow of gas to the molten portion. For example, additional cooling can be provided to prevent grain growth or coarsening of the microstructure of the sputtering target material after the molten portion has solidified.

The powder or particulate sputtering target material can be injected into the molten pool or onto the surface of the backing structure or substrate via a nozzle or other powder delivery device used in the art. For example, a nozzle can be provided with coaxial beam devices, such as coaxial lasers, to provide an improved part size.

The beam process can be conducted within a controlled atmosphere, such as an inert gas or vacuum or low pressure vacuum, to protect the materials of the process from contaminant and/or to prevent interference of gas atoms with a particle beam, such as an electron beam. Conversely, beam processing can be conducted in air if desired, including electron beam welding.

The beam processes described herein can be conducted manually or can be automated to ensure uniformity of the sputtering targets produced by these processes.

In addition, by using the beam process described herein a sputtering target is produced with a high density, low residual porosity, a composition with a relatively high uniformity, and a microstructure having fine, equiaxed grains.

### Direct Strip Casting

According to an embodiment, a direct strip casting method is provided to produce a sputtering target. In such a direct strip casting process, molten sputtering target material can be provided directly onto a surface of a roll where the sputtering target material solidifies to form a strip of solid sputtering target material with a uniform composition and fine microstructure. The sputtering target material can be, for example, a CIG alloy or any other material used in the art. The strip cast in this way may then be bonded to a backing structure or the strip may be directly cast onto the surface of a backing structure.

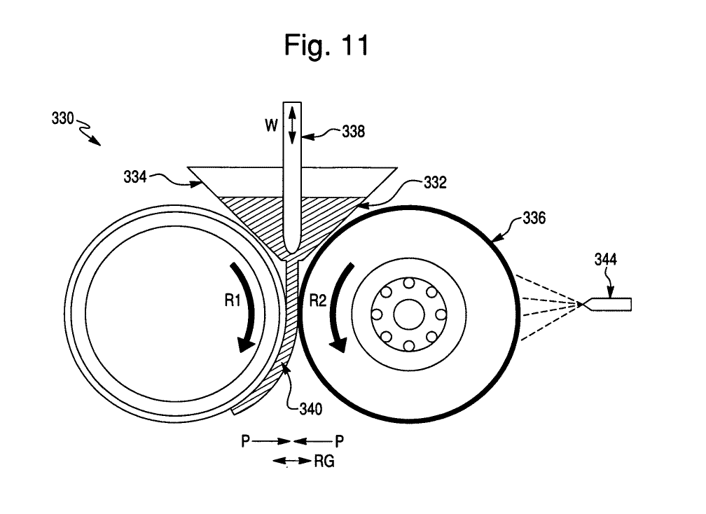

FIG. 11 shows an exemplary direct strip casting process 330 for producing a rotary sputtering target. In the example of FIG. 11, molten sputtering target material 332, such as liquid CIG, is provided within a ladle 334 or another reservoir. The ladle 334 is positioned above and between a roll 336 and a backing tube 342 that are rotated in opposite directions R1, R2. The rotation speeds of the roll 336 and backing tube 342 are substantially equal and can be adjusted in accordance with a feed rate of the molten sputtering target material, which can be in turn determined by a height of the pour plane.

A stopper plate 338 or another type of stopper is provided within the ladle 332. The stopper closes or stops shut a slot-shaped opening in the bottom of the ladle 332 and can be withdrawn vertically, as in the direction indicated by arrow W in the example of FIG. 11, permitting the molten sputtering target material to pour from the ladle 332 and between the roll 336 and the backing tube 342.

The roll 336 can be chilled to prevent adhesion of the molten sputtering target material to the roll 336 while the backing tube 342 can be heated to a predetermined temperature to promote adhesion and bonding of the molten sputtering target material to the backing tube 342 as the molten sputtering target material cools and begins to solidify into a strip 340. The strip 340 will initially be semi-solid but will further solidify as it cools. As shown in the example of FIG. 11, such an arrangement can cause the strip 340 to be bonded to the backing tube 342 to directly form a sputtering target in a direct strip casting process.

The roll 336 can be cooled, for example, by an external sprinkler 344 that applies coolant to the outer surface of the roll 336 to cool the roll 336 and to prevent sticking of sputtering target material to the roll 336. In another example, the roll 336 can be cooled internally to keep the roll 336 at a desired temperature.

A gap between the roll 336 and the backing tube 342 can be adjusted in the direction indicated by arrow RG in FIG. 11. The roll gap can adjusted in this way to control the thickness of the strip 340. In addition, the size of the slot at the bottom of the ladle 334 can be adjusted to affect the thickness of the cast strip. Furthermore, a pressure P applied to the sputtering target material between the roll 336 and the backing tube 342 can be adjusted to promote the closure of solidification-induced microporosity and to promote contact between the cooled roll 336 and the strip 340, which increases the withdrawal of heat from the strip 340 and in turn promotes grain refinement of the cast strip.

In another example, the ladle 334 and slot at the bottom of the ladle can be position off center of the gap between the roll 336 and the backing tube 342 so that the ladle and slot are shifted towards the backing tube 342 (i.e., to the left in FIG. 11). In this configuration, molten sputtering target material 332 poured from the ladle 334 through the slot impacts the backing tube 342 surface. The molten sputtering target material 332 causes a portion of the backing tube 342 to be covered with the sputtering target material as it impacts and solidifies into a strip 340 that is bonded to the backing tube 342. This impact and diffusion produces a diffusion bond layer at an interface of the strip 340 and the backing tube 342, which aids in the separation of the material of the roll 336 and the sputtering target material from one another.

In addition, by using the direct strip casting process described herein a sputtering target is produced with a high density, low residual porosity, a composition with a relatively high uniformity, and a microstructure having fine, equiaxed grains.

### Additional Processes

In addition to the processes described herein for manufacturing a sputtering target, additional methods may be utilized to produce a sputtering target. For example, extrusion, centrifugal casting, continuous casting, squeeze casting, or a thermal spray method, such as high velocity oxygen flame (HVOF) spraying, low velocity oxygen flame (LVOF) spraying, flame spraying, plasma spraying, arc spraying (including twin arc spraying), detonation gun spraying, and other processes used in the art.

### Bond Layer

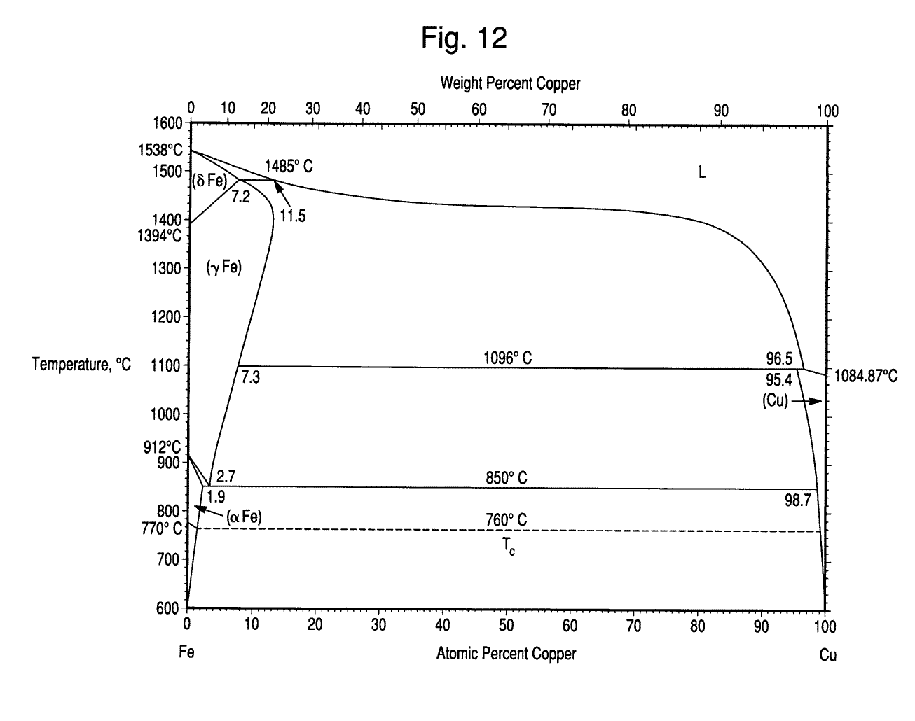

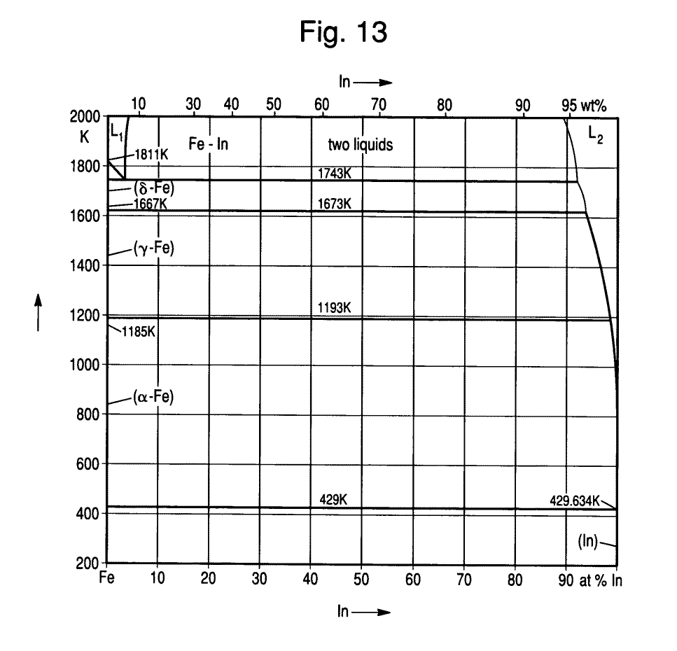

As shown in FIG. 12, which is the iron-copper phase diagram, and in FIG. 13, which is the iron-indium phase diagram, diffusion bonds are unlikely to develop at an interface directly between a stainless steel backing structure and a CIG alloy sputtering target material because both copper and indium have very little solubility in iron. Therefore, one or more bond layers can be advantageously used to promote bonding between a sputtering target material, such as a CIG alloy, and a backing structure.

Such bond layer(s) can facilitate joining of sputtering target material, such as a CIG material, to the backing structure, such as a stainless steel backing tube. The bond layer strength may be in excess of 1000 pounds per square inch and the bond layer should be resistant to thermal cycling that is associated with sputtering processes that could otherwise cause in-service de-bonding of the CIG material from the backing structure and failure of the sputtering target.

The bond layer can cause diffusional bonding, such as between the sputtering target material and the bond layer and/or between the bond layer and the backing structure, such as when the temperature of the bond layer is high enough to cause inter-diffusion among the atomic species of the bond layer and the atomic species of the sputtering target material and/or the backing structure material.

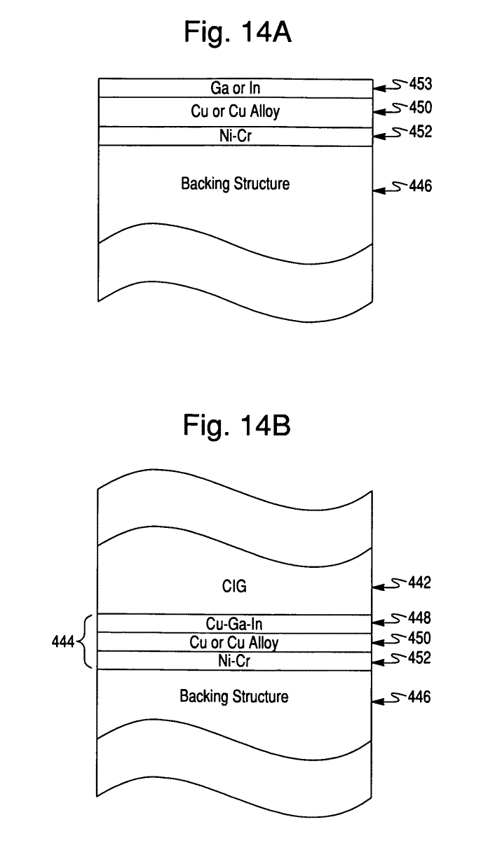

FIG. 14A shows an in-process sputtering target while FIG. 14B shows the completed sputtering target made by the process of FIG. 14A. In the example of FIGS. 14A and 14B, a sputtering target 440 is provided that includes sputtering target material 442, a bond layer 444, and a backing structure 446. As shown in the example of FIG. 14B, the bond layer 444 can include multiple layers, with the various layers providing different properties and attributes to promote adhesion between the sputtering target material 442 and the backing structure 446 and to minimize or prevent diffusion from the backing structure into the sputtering target material.

A bond layer can be formed of any one or more layers of material(s) that promotes the development of a diffusion bond at the interface between the sputtering target material and the bond layer. Such a bond layer(s) 444 can include, for example, a copper or a copper alloy compatible layer 450. The compatible layer can also act as a diffusion barrier layer to advantageously prevent the material of the backing structure 446 from dissolving into the sputtering target material 442, such as a CIG alloy. The materials of the stainless steel backing structure, such as, for example, iron, chromium, and nickel, can adversely affect the performance of photovoltaic cells if incorporated into a sputtered CIGS absorber layer.

The bond layer 444 can also include an optional bond coat layer 452 that strongly adheres to the backing structure 446 and provides a compatible bonding material for overlaying layers, such as a Cu or Cu alloy compatible layer 450. The bond coat layer 452 can be made of, for example, any suitable material which bonds to both the compatible layer 450 and the backing structure 446. For example, the bond coat layer 452 may comprise a nickel or aluminum alloy layer, such as nickel-chromium, nickel-copper or aluminum-copper bronze, and other non-ferromagnetic metals and alloys used in the art.

While a stainless steel backing structure 446 is described above, it should be noted that the backing structure may be made of other materials, such as aluminum or copper or Al or Cu alloys. In cases where the adhesion of the compatible layer 450 to the backing structure 46 is sufficiently strong, the optional bond coat layer 452 may be omitted. For a Cu or Cu alloy backing structure 446, both the compatible layer 450 and the optional bond coat layer 452 may be omitted.

Casting or molding the sputtering target material in a liquid or semi-solid (e.g., thixotropic) state of the CIG sputtering target material 442 (as well as some other methods described herein) may require a pre-heated backing structure to promote interdiffusion of the sputtering target material and the material of the backing structure. However, such pre-heating could lead to oxidation of the bond layer, such as when the bond layer includes copper or a copper alloy compatible layer and/or to oxidation of the backing structure if the backing structure itself is made from a copper or copper alloy. Thus, the bond layer (or the Cu or Cu alloy backing structure) may be protected by a protective coating or may be processed under a protective atmosphere, such as a vacuum, low pressure vacuum, or inert atmosphere. As shown in FIG. 14A, the protective coating can be, for example, a layer 453 of gallium, indium or both gallium and indium (e.g., In—Ga alloy). Such layers of gallium and/or indium are capable of resisting oxidation at high temperature in open air and can produce strong bonds with the sputtering target material, such as a CIG alloy. The protective coating is preferably applied as a liquid film that wets the surface of the Cu or Cu alloy. Such a liquid film can advantageously enhance wetting of the bond layer by the sputtering target material, such as when molten sputtering target material 442 is cast onto the bond layer 444, thus promoting a more efficient diffusion bonding process. The liquid In and/or Ga protective coating 453 may solidify after application, and only liquefy again later when molten CIG target material 442 is applied. Therefore, the subsequent step of forming the diffusion bond does not require the In and/or Ga coating 453 to remain liquid between its application and the pouring of the molten CIG target material 442. In an alternative embodiment, the protective coating 453 may be applied by some other method, such as sputtering.

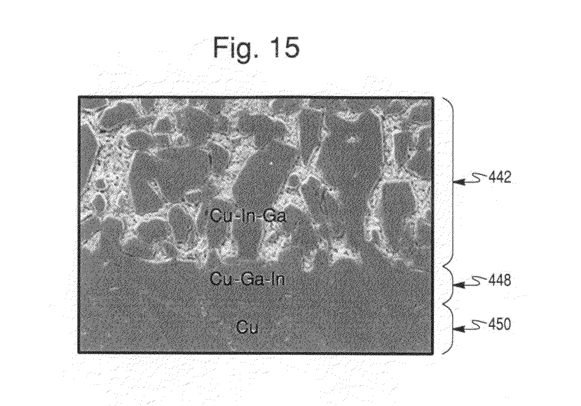

As shown in FIG. 14B, the CIG sputtering target material 442 is formed over the protective coating 453. The protective coating 453 disappears as a distinct layer, and in its place diffusion bond layer 448 is formed, which promotes adhesion of the sputtering target material 442 to the underlying layers, such as the compatible layer 450. For example, the layers may be processed, such as by heating the layers to an elevated temperature during casting and/or after casting, to promote interdiffusion through the diffusion bond layer 448 of the constituents of the sputtering target material 442 and/or the compatible layer 450. Thus, it is believed that Cu from the compatible layer 450 and/or from material 442 produce a diffusion bond layer 448 including Cu and at least one of In and Ga between the sputtering target material 442 and the compatible layer 450. FIG. 15 is a micrograph showing a side cross section view of an exemplary sputtering target including sputtering target material 442, a compatible layer 450, and a diffusion bond layer 448. The compatible layer 450 is made of copper, the diffusion bond layer 448 includes Cu, Ga and In, and the target material 442 comprises CIG.

The layers 453, 450 and/or 452 can be deposited by any suitable techniques used in the art such as, for example, thermal deposition, electro- or electro-less plating, chemical or physical vapor deposition (CVD or PVD). Preferably, protective coating 453 is applied in molten form by brush. In another example, when a bond layer 444 includes various layers, such as a bond coat layer 452, a compatible layer 450, and a protective coating 453, the various layers can be deposited by different techniques or the same technique. For example, the bond coat layer 362 can be deposited by thermal spray while the protective coating 453 may be deposited by dipping the structure into liquid In and/or Ga.

The bond layer described above can be used with the various processes described herein to manufacture a sputtering target.

In the above described embodiments, the entire CIG target material is preferably formed in a single piece directly on the backing tube. According to an alternative embodiment, segments of a target material may be separately formed by the above methods followed by bonding to the backing tube. Preferably, the CIG segments have a shape of a hollow ring or tube (i.e., a section of a hollow cylinder with a hole along the central axis large enough to accommodate the backing tube).

One method of bonding such segments to the backing tube is to use a bonding layer of indium. The indium bonding layer is applied to the outer surface of the backing tube and/or to the inner surfaces or inner diameters of the hollow tube shaped CIG segments. However, such a process requires heating the segments above the melting point of indium, 156° C., which approximates the solidus temperature for many CIG alloys of interest, thus resulting in partial melting of many CIG alloys during the bonding process.

An alternative bonding process uses an alloy of indium and gallium that melts at a temperature below 156° C. The relative portions of indium and gallium can be varied to provide any melting point between 16° C. and 156° C. Optionally, one or more other alloying elements may be added. One issue to consider when using such bonding alloys is the possibility of atoms of the cast segment diffusing into the bonding alloy, thus changing the composition and properties of the bonding alloy and vise-versa. To avoid this, a thin layer of barrier material may be deposited on areas of the segment where there such a concern, such as the inner diameter of the segment. Such a barrier layer can be made of any non-ferromagnetic metal with a melting point above the bonding temperature, such as, for example, Cu, Ti, Ta, Zr, Sn, Zn, V, Nb, Mo, their alloys or 300 series stainless steel. Al is not a desirable bonding material for segments cast from CIG alloys because Al can be embrittled by gallium.

### CONCLUSION

While CIG alloy target manufacturing methods have been described above, it should be noted that sputtering targets of other materials may be formed using similar methods. For example, copper indium, copper indium aluminum, copper indium gallium diselenide, CIG plus additional alloying elements and other metals or non-metals or their alloy targets may be formed. Thus, while a pure CIG alloy is described above, it should be noted that the CIG alloy may contain other alloying elements. For example, the alloy may contain Na, Al and/or Se in addition to copper, indium and gallium.

It is to be understood that the present invention is not limited to the embodiment(s) and the example(s) described above and illustrated herein, but encompasses any and all variations falling within the scope of the appended claims. Any feature of any embodiment described herein can be used in combination with any other one or more features of any one or more embodiments described herein.

1. A sputtering target, comprising: a copper indium gallium sputtering target material on a backing structure,
wherein:
the sputtering target material has a density of at least 100% or more as defined by the rule of mixtures applied to densities of component elements of the sputtering target material; and
the sputtering target material has an overall uniform composition.

2. A sputtering target as claimed in claim 1, wherein the backing structure comprises a hollow tube and the sputtering target material is formed over an outer surface of the hollow tube.

3. A sputtering target as claimed in claim 1, wherein the backing structure has a planar shape.

4. A sputtering target as claimed in claim 1, wherein:
from 0% to 10% of primary phase regions in the sputtering target material are of a size greater than 100 μm in any random 1 cm by 1 cm area of the sputtering target;
an average primary phase region in the sputtering target material is of a size not greater than 40 μm; and
the sputtering target material has an overall uniform composition.

5. A sputtering target as claimed in claim 1, wherein the sputtering target material has an overall uniform composition of about 29-39 wt % copper, about 49-62 wt % indium, and about 8-16 wt % gallium.

6. A sputtering target as claimed in claim 1, wherein:
the sputtering target material does not contain inclusions or pores greater than a 100 μm diameter sphere in size; and
the sputtering target material does not contain pores or cracks having a distance larger than 1000 μm.

7. A sputtering target as claimed in claim 6, wherein:
the sputtering target material does not contain inclusions or pores greater than a 50 μm diameter sphere in size; and
the sputtering target material does not contain pores or cracks having a distance larger than 500 μm.

8. A sputtering target as claimed in claim 1, wherein:
the sputtering target material has a density of 100% to 107% as determined by a rule of mixtures; and
the sputtering target material contains 0 to 3 vol % porosity.

9. A method of making a sputtering target, comprising:
providing a backing structure, and
forming a copper indium gallium sputtering target material on the backing structure,
wherein:
the sputtering target material has a density at least 100% or more as defined by the rule of mixtures applied to the densities of the component elements; and
the sputtering target material has an overall uniform composition.

10. A method as claimed in claim 9, wherein the backing structure comprises a hollow tube and the sputtering target material is formed on an outer surface of the hollow tube.

11. A method as claimed in claim 9, wherein the backing structure has a planar shape.

12. A method as claimed in claim 9, wherein the sputtering target material is formed onto the backing structure by direct forging.

13. A method as claimed in claim 12, wherein the direct forging comprises forcing a semi-solid or a solid billet onto a cylindrical backing tube.

14. A method as claimed in claim 9, wherein the sputtering target material is formed by a welding process.

15. A method as claimed in claim 14, wherein the sputtering target material is formed by electrical or gas welding.

16. A method as claimed in claim 14, wherein the sputtering target material is formed by laser welding or electron beam welding.

17. A method as claimed in claim 9, wherein the sputtering target material is formed by powder metallurgy.

18. A method as claimed in claim 9, wherein the sputtering target material is formed by casting or molding copper indium gallium material in a thixotropic state.

19. A method as claimed in claim 9, wherein the sputtering target material is formed by metal injection molding.

20. A method as claimed in claim 9, wherein the sputtering target material is formed by zone melting.

21. A method as claimed in claim 9, wherein the sputtering target material is formed by vacuum casting.

22. A method as claimed in claim 9, wherein the sputtering target material is formed by strip casting.

23. A method as claimed in claim 9, wherein the sputtering target material is formed by backwards flow pressing.

24. A method as claimed in claim 9, wherein the sputtering target material is formed by dip casting.

25. A method as claimed in claim 9, wherein the sputtering target material is formed by forming at least one hollow ring or tube shaped segment of the sputtering target material.

26. A method as claimed in claim 9, wherein the sputtering target material is formed by directly forming the sputtering target material onto a cylindrical backing structure.

27. A method as claimed in claim 9, wherein the sputtering target material is formed by uniaxial pressing of at least one hollow ring or tube segment of the sputtering target material.

28. A method as claimed in claim 27, wherein the step of uniaxial pressing comprises providing copper indium gallium powder around a cylindrical backing structure and uniaxially pressing the powder substantially parallel to a longitudinal axis of the cylindrical backing structure.

29. A method as claimed in claim 27, wherein the step of uniaxial pressing comprises uniaxially pressing copper indium gallium powder in a direction substantially parallel to a longitudinal axis of the at least one segment and followed by joining the at least one segment to the cylindrical backing structure.

30. A method as claimed in claim 9, further comprising providing a bond coat comprising indium, gallium or indium gallium alloy between the backing structure and the sputtering target material.

31. A method as claimed in claim 9, wherein the sputtering target material is formed by rapid cooling or rapid solidification of the sputtering target material on the backing structure at rate of 1-100° C./s.

32. A method as claimed in claim 9, wherein:
from 0% to 10% of primary phase regions in the sputtering target material are of a size greater than 100 μm in any random 1 cm by 1 cm area of the sputtering target;
an average primary phase region in the sputtering target material is of a size not greater than 40 μm; and
the sputtering target material has an overall uniform composition.

33. A method as claimed in claim 9, wherein the sputtering target material has an overall uniform composition of about 29-39 wt % copper, about 49-62 wt % indium, and about 8-16 wt % gallium.

34. A method as claimed in claim 9, wherein:
the sputtering target material does not contain inclusions or pores greater than a 100 μm diameter sphere in size; and
the sputtering target material does not contain pores or cracks having a distance larger than 1000 μm.

35. A method as claimed in claim 9, wherein:
the sputtering target material has a density of 100% to 107% as determined by a rule of mixtures;
the sputtering target material contains 0 to 3 vol % porosity;
the sputtering target material does not contain inclusions or pores greater than a 50 μm diameter sphere in size; and
the sputtering target material does not contain pores or cracks having a distance larger than 500 μm.

36. A method of making a sputtering target, comprising:
providing a backing structure, and
forming a copper indium gallium sputtering target material on the backing structure,
wherein the sputtering target material is formed on the backing structure by a process selected from the group consisting of:
direct forging,
welding,
casting or molding the sputtering target material in a thixotropic state,
metal injection molding,
zone melting,
vacuum casting,
strip casting,
backwards flow pressing,
roll dip casting, and
uniaxial pressing of a powder to form at least one hollow ring or tube segment of the sputtering target material.

37. A method as claimed in claim 36, wherein:
from 0% to 10% of primary phase regions in the sputtering target material are of a size greater than 100 μm in any random 1 cm by 1 cm area of the sputtering target;
an average primary phase region in the sputtering target material is of a size not greater than 40 μm; and
the sputtering target material has an overall uniform composition.

38. A method as claimed in claim 36, wherein the sputtering target material has an overall uniform composition of about 29-39 wt % copper, about 49-62 wt % indium, and about 8-16 wt % gallium.

39. A method as claimed in claim 36, wherein:
the sputtering target material has a density of 100% to 107% as determined by a rule of mixtures;
the sputtering target material contains 0 to 3 vol % porosity;
the sputtering target material does not contain inclusions or pores greater than a 100 μm diameter sphere in size; and
the sputtering target material does not contain pores or cracks having a distance larger than 1000 μm.

40. A method as claimed in claim 36, wherein:
the sputtering target material has a density of 100% to 107% as determined by a rule of mixtures;
the sputtering target material contains 0 to 3 vol % porosity;
the sputtering target material does not contain inclusions or pores greater than a 50 μm diameter sphere in size; and
the sputtering target material does not contain pores or cracks having a distance larger than 500 μm.

41. A method as claimed in claim 36, further comprising forming at least one bonding layer between the backing structure and the sputtering target material.

42. A method as claimed in claim 36, wherein:
the step of forming the at least one bonding layer comprises forming a Cu or Cu alloy compatible layer over the backing structure and forming a protective liquid In, Ga or In—Ga alloy film over the compatible layer; and
the In, Ga or In—Ga alloy film forms a Cu—In—Ga diffusion bond layer between the copper indium gallium sputtering target material and the compatible layer.

43. A method as claimed in claim 18, wherein:
the backing structure comprises a stainless steel backing structure.

44. A method as claimed in claim 43, wherein:
the step of forming the at least one bonding layer further comprises forming a nickel or aluminum alloy bond coat layer between the compatible layer and the backing structure.

45. A method as claimed in claim 36, wherein:
the step of forming the at least one bonding layer comprises forming a protective liquid In, Ga or In—Ga alloy film over a Cu or Cu alloy backing structure; and
a Cu—In—Ga diffusion bond layer is formed between the copper indium gallium sputtering target material and the backing structure.
